(19) United States
(12) Patent Application Publication
(10) Pub. No.: US 2025/0234170 A1
(43) Pub. Date: Jul. 17, 2025

(54) INTER-RADIO ACCESS TECHNOLOGY COEXISTENCE SYSTEMS

(71) Applicant: QUALCOMM Incorporated, San Diego, CA (US)

(72) Inventors: Tien Viet NGUYEN, Bridgewater, NJ (US); Hui GUO, Beijing (CN); Shuanshuan WU, San Diego, CA (US); Gabi SARKIS, San Diego, CA (US); Sourjya DUTTA, Jersey City, NJ (US); Kapil GULATI, Belle Mead, NJ (US)

(21) Appl. No.: 18/879,722

(22) PCT Filed: Aug. 18, 2022
(86) PCT No.: PCT/CN2022/113228

§ 371 Date: Dec. 27, 2024

(51) Int. Cl. H04W 4/40; H04W 72/0446; H04W 72/40; H04W 72/542; H04W 72/566

(52) U.S. Cl. CPC H04W 4/40; H04W 72/0446; H04W 72/40; H04W 72/542; H04W 72/566

(57) ABSTRACT

A first wireless device may receive a first indication of a set of first slots associated with a first vehicle-to-everything (V2X) transmission from a second wireless device, wherein the first set of V2X transmissions is associated with a first radio access technology (RAT). The first wireless device may communicate a second indication of a set of second slots associated with second set of V2X transmissions, wherein the second set of V2X transmissions are subsequent to the first set of V2X transmissions, wherein the second set of V2X transmissions are associated with the first RAT, wherein the second indication is based on at least one of: (1) a reference signal received power (RSRP) associated with the first set of V2X transmissions being greater than an RSRP threshold or (2) a distance between the first wireless device and the second wireless device being less than a threshold distance.

### TECHNICAL FIELD

The present disclosure relates generally to communication systems, and more particularly, to systems that support the coexistence of different radio access technologies (RATs).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may have a memory and at least one processor coupled to the memory at a first wireless device. Based at least in part on information stored in the memory, the at least one processor may be configured to receive a first indication of a set of first slots associated with a first vehicle-to-everything (V2X) transmission from a second wireless device. The first set of V2X transmissions may be associated with a first radio access technology (RAT). Based at least in part on information stored in the memory, the at least one processor may further be configured to communicate a second indication of a set of second slots associated with second set of V2X transmissions. The second set of V2X transmissions may be subsequent to the first set of V2X transmissions. The second set of V2X transmissions may be associated with the first RAT. The second indication may be based on at least one of: (1) a reference signal received power (RSRP) associated with the first set of V2X transmissions being greater than an RSRP threshold or (2) a distance between the first wireless device and the second wireless device being less than a threshold distance.

In an aspect of the disclosure, a method, a computer-readable medium, and an apparatus are provided. The apparatus may have a memory and at least one processor coupled to the memory at a third wireless device. Based at least in part on information stored in the memory, the at least one processor may be configured to obtain an indication of a set of second slots associated with a second set of V2X transmissions. The second set of V2X transmissions may be subsequent to a first set of V2X transmissions associated with a set of first slots. The set of first slots and the set of second slots may be associated with a first candidate resource set. The first set of V2X transmissions and the second set of V2X transmissions may be between a first wireless device and a second wireless device. The first set of V2X transmissions may be associated with a first RAT and the second set of V2X transmissions are associated with the first RAT. The indication may be based on at least one of: (1) a reference signal received power (RSRP) associated with the first set of V2X transmissions being greater than an RSRP threshold or (2) a distance between the first wireless device and the second wireless device being less than a threshold distance. Based at least in part on information stored in the memory, the at least one processor may be configured to refrain from transmitting a third V2X transmission in the set of second slots that interfere with the first candidate resource set associated with the second set of V2X transmissions based on the indication. The third V2X transmission may be associated with a second RAT different from the first RAT.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2 illustrates example aspects of a sidelink slot structure.

FIG. 3 is a diagram illustrating an example of a base station and user equipment (UE) in an access network.

FIG. 4 illustrates example aspects of sidelink communication between devices, in accordance with aspects presented herein.

FIG. 5 illustrates examples of a resource reservation system for sidelink communication.

FIG. 6 illustrates examples of another resource reservation system for sidelink communication.

FIG. 7 illustrates example aspects of V2X communication between devices, in accordance with aspects presented herein.

FIG. 8 illustrates a connection flow diagram between wireless devices, in accordance with aspects presented herein.

FIG. 9 illustrates additional example aspects of V2X communication between devices, in accordance with aspects presented herein.

FIG. 10 illustrates a connection flow diagram between wireless devices, in accordance with aspects presented herein.

FIG. 11 illustrates additional example aspects of V2X communication between devices, in accordance with aspects presented herein.

FIG. 12 illustrates a connection flow diagram between wireless devices, in accordance with aspects presented herein.

FIG. 13 illustrates a connection flow diagram between wireless devices, in accordance with aspects presented herein.

FIG. 14 illustrates additional example aspects of V2X communication between devices, in accordance with aspects presented herein.

FIG. 15 illustrates a connection flow diagram between wireless devices, in accordance with aspects presented herein.

FIG. 16 is a flowchart of a method of wireless communication.

FIG. 17 is another flowchart of a method of wireless communication.

FIG. 18 is another flowchart of a method of wireless communication.

FIG. 19 is another flowchart of a method of wireless communication.

FIG. 20 is another flowchart of a method of wireless communication.

FIG. 21 is another flowchart of a method of wireless communication.

FIG. 22 is a diagram illustrating an example of a hardware implementation for an example apparatus.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may further include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmit receive point (TRP), or a cell, etc.) may be implemented as an aggregated base station (i.e., a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN) (i.e., a cloud radio access network (C-RAN). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

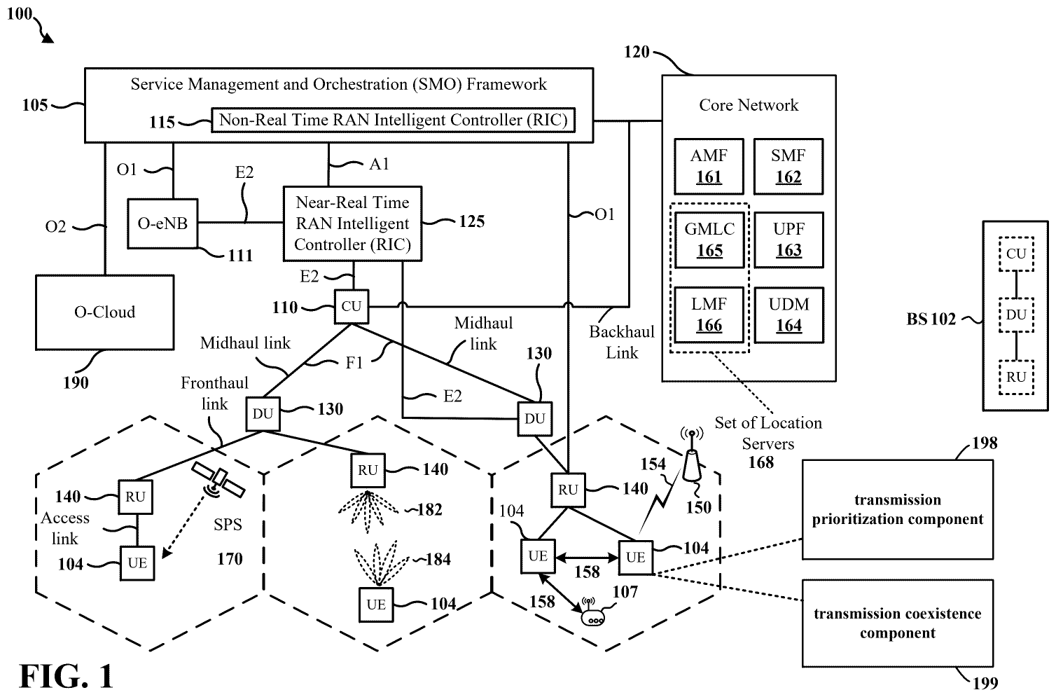

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 may further include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may further include Home Evolved Node Bs (eNBs) (HeNBs), which may provide service to a restricted group known as a closed subscriber group (CSG). The communication links between the RUs 140 and the UEs 104 may include uplink (UL) (i.e., reverse link) transmissions from a UE 104 to an RU 140 and/or downlink (DL) (i.e., forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

One or more UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

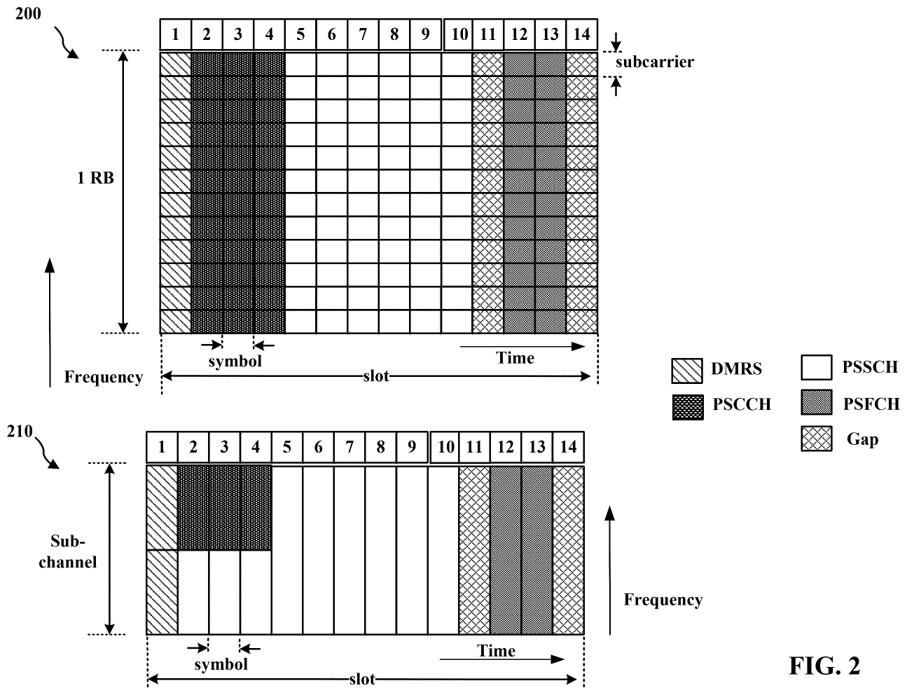

Some examples of D2D communication may include vehicle-based communication devices that can communicate from vehicle-to-vehicle (V2V), vehicle-to-infrastructure (V21) (e.g., from the vehicle-based communication device to road infrastructure nodes such as a Road Side Unit (RSU)), vehicle-to-network (V2N) (e.g., from the vehicle-based communication device to one or more network nodes, such as a base station), vehicle-to-pedestrian (V2P), cellular vehicle-to-everything (C-V2X), and/or a combination thereof and/or with other devices, which can be collectively referred to as vehicle-to-anything (V2X) communications. Sidelink communication may be based on V2X or other D2D communication, such as Proximity Services (ProSe), etc. In addition to UEs, sidelink communication may further be transmitted and received by other transmitting and receiving devices, such as Road Side Unit (RSU) 107, etc. Sidelink communication may be exchanged using a PC5 interface, such as described in connection with the example in FIG. 2. Although the following description, including the example slot structure of FIG. 2, may provide examples for sidelink communication in connection with 5G NR, the concepts described herein may be applicable to other similar areas, such as LTE, LTE-A, CDMA, GSM, and other wireless technologies.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FRI (410 MHz-7.125 GHz) and FR2 (24.25 GHz-52.6 GHz). Although a portion of FR1 is greater than 6 GHz, FRI is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may further transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some aspects, the term UE may apply to one or more companion devices such as in a device constellation arrangement. One or more of these devices may collectively access the network and/or individually access the network.

Referring again to FIG. 1, in certain aspects, the UE 104 may include a transmission prioritization component 198. The transmission prioritization component 198 may be configured to receive a first indication of a set of first slots associated with a first set of V2X transmissions from a second wireless device. The first set of V2X transmissions may be associated with a first RAT. The transmission prioritization component 198 may be configured to communicate a second indication of a set of second slots associated with second set of V2X transmissions. The second set of V2X transmissions may be subsequent to the first set of V2X transmissions. The second set of V2X transmissions may be associated with the first RAT. The second indication may be based on at least one of: (1) a reference signal received power (RSRP) associated with the first set of V2X transmissions being greater than an RSRP threshold or (2) a distance between the first wireless device and the second wireless device being less than a threshold distance.

In certain aspects, the UE 104 may include a transmission coexistence component 199. The transmission coexistence component 199 may be configured to obtain an indication of a set of second slots associated with a second set of V2X transmissions. The second set of V2X transmissions may be subsequent to a first set of V2X transmissions associated with a set of first slots. The set of first slots and the set of second slots may be associated with a first candidate resource set. The first set of V2X transmissions and the second set of V2X transmissions may be between a first wireless device and a second wireless device. The first set of V2X transmissions may be associated with a first RAT and the second set of V2X transmissions are associated with the first RAT. The indication may be based on at least one of: (1) an RSRP associated with the first set of V2X transmissions being greater than an RSRP threshold or (2) a distance between the first wireless device and the second wireless device being less than a threshold distance. The transmission coexistence component 199 may be configured to refrain from transmitting a third V2X transmission in the set of second slots that interfere with the first resource set associated with the second set of V2X transmissions based on the indication. The third V2X transmission may be associated with a second RAT different from the first RAT.

The transmission prioritization component 198 and the transmission coexistence component 199 may be referred to as a single wireless device capable of transmitting and receiving transmissions using at least two different RATs, or may be referred to as different wireless devices, each of which may be capable of transmitting and receiving transmissions using different RATs from one another. Although the following description may be focused on V2X, the concepts described herein may be applicable to other similar areas, such as sidelink or wireless devices communicating using any other D2D communication link. Although the following description may be focused on D2D communication links using 5G NR and LTE, the concepts described herein may be applicable to other similar areas, such as LTE-A, CDMA, GSM, and other wireless technologies.

FIG. 2 includes diagrams 200 and 210 illustrating example aspects of slot structures that may be used for sidelink communication (e.g., between UEs 104, RSU 107, etc.). The slot structure may be within a 5G/NR frame structure in some examples. In other examples, the slot structure may be within an LTE frame structure. Although the following description may be focused on 5G NR, the concepts described herein may be applicable to other similar areas, such as LTE, LTE-A, CDMA, GSM, and other wireless technologies. The example slot structure in FIG. 2 is merely one example, and other sidelink communication may have a different frame structure and/or different channels for sidelink communication. A frame (10 ms) may be divided into 10 equally sized subframes (1 ms). Each subframe may include one or more time slots. Subframes may include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. Diagram 200 illustrates a single resource block of a single slot transmission, e.g., which may correspond to a 0.5 ms transmission time interval (TTI). A physical sidelink control channel may be configured to occupy multiple physical resource blocks (PRBs), e.g., 10, 12, 15, 20, or 25 PRBs. The PSCCH may be limited to a single sub-channel. A PSCCH duration may be configured to be 2 symbols or 3 symbols, for example. A sub-channel may include 10, 15, 20, 25, 50, 75, or 100 PRBs, for example. The resources for a sidelink transmission may be selected from a resource pool including one or more subchannels. As a non-limiting example, the resource pool may include between 1-27 subchannels. A PSCCH size may be established for a resource pool, e.g., as between 10-100% of one subchannel for a duration of 2 symbols or 3 symbols. The diagram 210 in FIG. 2 illustrates an example in which the PSCCH occupies about 50% of a subchannel, as one example to illustrate the concept of PSCCH occupying a portion of a subchannel. The physical sidelink shared channel (PSSCH) occupies at least one subchannel. The PSCCH may include a first portion of sidelink control information (SCI), and the PSSCH may include a second portion of SCI in some examples.

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 2, some of the REs may include control information in PSCCH and some REs may include demodulation RS (DMRS). At least one symbol may be used for feedback. FIG. 2 illustrates examples with two symbols for a physical sidelink feedback channel (PSFCH) with adjacent gap symbols. A symbol prior to and/or after the feedback may be used for turnaround between reception of data and transmission of the feedback. The gap enables a device to switch from operating as a transmitting device to prepare to operate as a receiving device, e.g., in the following slot. Data may be transmitted in the remaining REs, as illustrated. The data may include the data message described herein. The position of any of the data, DMRS, SCI, feedback, gap symbols, and/or listen before talk (LBT) symbols may be different than the example illustrated in FIG. 2. Multiple slots may be aggregated together in some aspects.

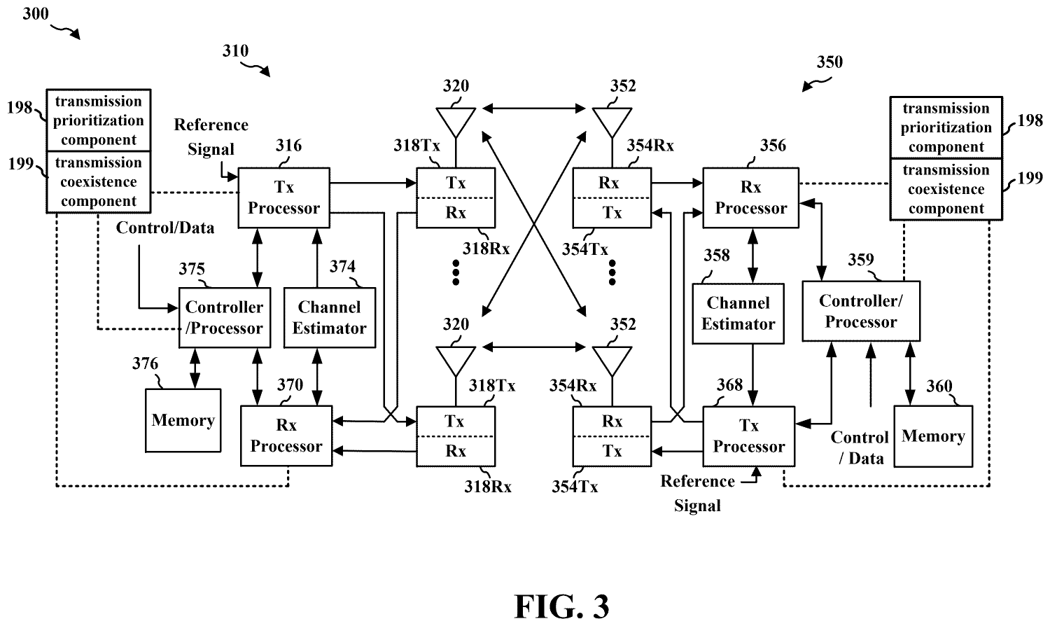

FIG. 3 is a block diagram 300 of a first wireless communication device 310 in communication with a second wireless communication device 350 based on sidelink. In some examples, the devices 310 and 350 may communicate based on V2X or other D2D communication. The communication may be based on sidelink using a PC5 interface. The devices 310 and the device 350 may include a UE, an RSU, a base station, etc. Packets may be provided to a controller/processor 375 that implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer.

The transmit (Tx) processor 316 and the receive (Rx) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The Tx processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the device 350. Each spatial stream may then be provided to a different antenna 320 via a separate transmitter 318Tx. Each transmitter 318Tx may modulate an RF carrier with a respective spatial stream for transmission.

At the device 350, each receiver 354Rx receives a signal through its respective antenna 352. Each receiver 354Rx recovers information modulated onto an RF carrier and provides the information to the receive (Rx) processor 356. The Tx processor 368 and the Rx processor 356 implement layer 1 functionality associated with various signal processing functions. The Rx processor 356 may perform spatial processing on the information to recover any spatial streams destined for the device 350. If multiple spatial streams are destined for the device 350, they may be combined by the Rx processor 356 into a single OFDM symbol stream. The Rx processor 356 then converts the OFDM symbol stream from the time-domain to the frequency domain using a Fast Fourier Transform (FFT). The frequency domain signal may include a separate OFDM symbol stream for each subcarrier of the OFDM signal. The symbols on each subcarrier, and the reference signal, are recovered and demodulated by determining the most likely signal constellation points transmitted by device 310. These soft decisions may be based on channel estimates computed by the channel estimator 358. The soft decisions are then decoded and deinterleaved to recover the data and control signals that were originally transmitted by device 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. The controller/processor 359 may provide demultiplexing between transport and logical channels, packet reassembly, deciphering, header decompression, and control signal processing. The controller/processor 359 may be responsible for error detection using an ACK and/or NACK protocol to support HARQ operations.

Similar to the functionality described in connection with the transmission by device 310, the controller/processor 359 may provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by device 310 may be used by the Tx processor 368 to select the appropriate coding and modulation schemes, and to facilitate spatial processing. The spatial streams generated by the Tx processor 368 may be provided to different antenna 352 via separate transmitters 354Tx. Each transmitter 354Tx may modulate an RF carrier with a respective spatial stream for transmission.

The transmission is processed at the device 310 in a manner similar to that described in connection with the receiver function at the device 350. Each receiver 318Rx receives a signal through its respective antenna 320. Each receiver 318Rx recovers information modulated onto an RF carrier and provides the information to a Rx processor 370.

The controller/processor 375 can be associated with a memory 376 that stores program codes and data. The memory 376 may be referred to as a computer-readable medium. The controller/processor 375 provides demultiplexing between transport and logical channels, packet reassembly, deciphering, header decompression, control signal processing. The controller/processor 375 may be responsible for error detection using an ACK and/or NACK protocol to support HARQ operations.

At least one of the Tx processor 368, the Rx processor 356, and the controller/processor 359 may be configured to perform aspects in connection with transmission prioritization component 198 of FIG. 1.

At least one of the Tx processor 368, the Rx processor 356, and the controller/processor 359 may be configured to perform aspects in connection with transmission coexistence component 199 of FIG. 1.

At least one of the Tx processor 316, the Rx processor 370, and the controller/processor 375 may be configured to perform aspects in connection with transmission prioritization component 198 of FIG. 1.

At least one of the Tx processor 316, the Rx processor 370, and the controller/processor 375 may be configured to perform aspects in connection with transmission coexistence component 199 of FIG. 1.

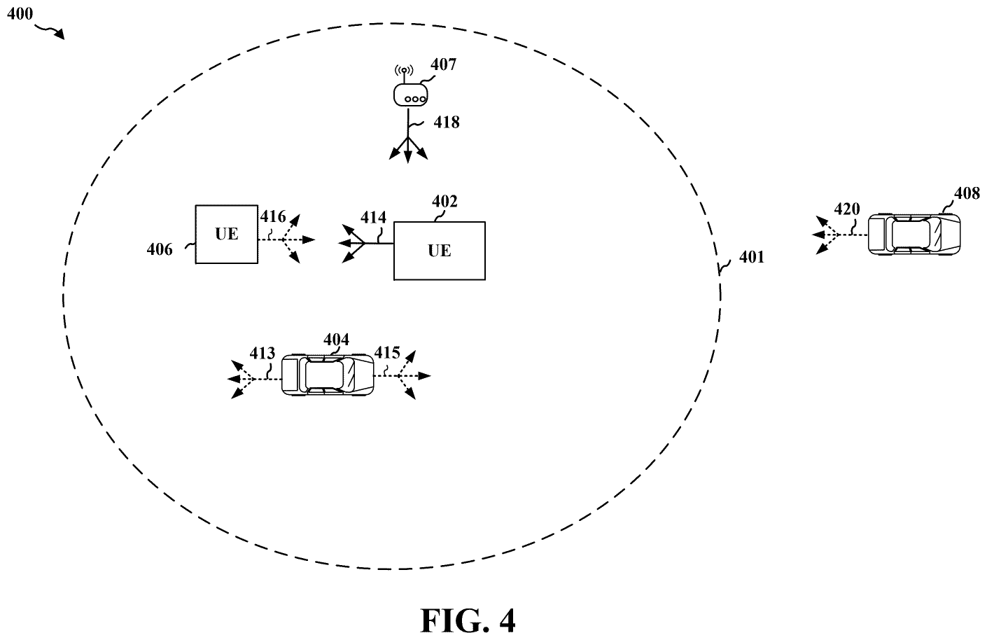

FIG. 4 illustrates an example 400 of sidelink communication between devices. The communication may be based on a slot structure including aspects described in connection with FIG. 2. For example, the UE 402 may transmit a sidelink transmission 414, e.g., including a control channel (e.g., PSCCH) and/or a corresponding data channel (e.g., PSSCH), that may be received by UEs 404, 406, 408. A control channel may include information (e.g., sidelink control information (SCI)) for decoding the data channel including reservation information, such as information about time and/or frequency resources that are reserved for the data channel transmission. For example, the SCI may indicate a number of TTIs, as well as the RBs that may be occupied by the data transmission. The SCI may be used by receiving devices to avoid interference by refraining from transmitting on the reserved resources. The UEs 402, 404, 406, 408 may each be capable of sidelink transmission in addition to sidelink reception. Thus, UEs 404, 406, 408 are illustrated as transmitting sidelink transmissions 413, 415, 416, 420. The sidelink transmissions 413, 414, 415, 416, 420 may be unicast, broadcast or multicast to nearby devices. For example, UE 404 may transmit sidelink transmissions 413, 415 intended for receipt by other UEs within a range 401 of UE 404, and UE 406 may transmit sidelink transmission 416. Additionally, or alternatively, RSU 407 may receive communication from and/or transmit communication transmission 418 to UEs 402, 404, 406, 408. One or more of the UEs 402, 404, 406, 408 or the RSU 407 may include a transmission prioritization component 198 and/or a transmission coexistence component 199 as described in connection with FIG. 1.

Sidelink communication may be based on one or more transmission modes. In one transmission mode for a first radio access technologies (RAT) (which may be referred to herein as “Mode 4” of a first RAT), a wireless device may autonomously select resources for transmission. A network entity may allocate one or more sub-channels for wireless devices to transmit one or more transport blocks (TB) using the one or more channels. A wireless device may randomly reserve an allocated resource for one-shot transmissions. A wireless device may use a sensing-based semi-persistent transmission scheme, or semi-persistent scheduling (SPS) mode, to select a reserved resource for transmission. For example, before selecting a resource for data transmission, a wireless device may first determine whether resources have been reserved by another wireless device. Semi-persistent transmission allows a wireless device to take advantage of semi-periodic traffic arrival by using historical interference patterns to predict future interference patterns. The wireless device may sense at least one of priority information, energy sensing information, or PSCCH decoding information to optimize resource selection. In one aspect, a wireless device may avoid selecting resources for a transmission that are scheduled to be used for a higher priority packet transmission. In another aspect, a wireless device may rank resources according to how much energy is received, and may pick the lowest energy resources. In another aspect, a wireless device may avoid resources for whom control is decoded or for which the received energy may be above a threshold.

A network entity may configure the periodicity of the reserved sub-channels using DCI transmitted over a PDCCH. The period of a semi-persistent transmission resource may be, for example, 20, 50, 100, 200, 300, 400, 500, 600, 700, 800, 900, or 1000 milliseconds (ms). Such a periodicity may be referred to as a resource reservation period (RSVP). In alternative embodiments, the periodicity may be referred to as an resource reservation interval (RRI). A network entity may limit the possible values for the periodicity of the transmission resource. A wireless device, such as a UE, may select a transmission resource based on the periodicity of an arrival packet. A counter may be used to trigger periodic reselections. For example, a wireless device may randomly select a counter between 5 and 15, and may reserve a resource based on the counter (e.g., 10*counter resource reservation periods, a number of MAC protocol data unit (PDU) transmissions equal to the counter). After every transmission, or after a reservation period passes, the counter may be decremented until it hits zero. For example, where a reservation period is 100 ms and a counter is 10, every 100 ms the counter may decrement until one second(s) passes, upon which the wireless device may then reselect a sidelink resource. In one aspect, the wireless device may reselect the sidelink resource based on a re-selection probability value. For example, in response to the counter decrementing to zero, the wireless device may reselect the sidelink resource an x % of the time, and may not reselect the sidelink resource (1−x) % of the time, where x<1. The wireless device may then reset the counter and repeat the process when the counter decrements to zero again. A wireless device may measure a received signal strength indicator (RSSI) measurement for each slot of 100 ms, and may then calculate the RSSI of the frequency band resource as an average of each of the 10 RSSI measurements taken over the period of one second. A wireless device may select a preferred frequency band resource as a resource that is in one of the bottom 20% of ranked RSSI calculated resources for a wireless device. In some aspects, the counter may be decremented after every MAC PDU transmission. A wireless device may be configured to reselect a sidelink resource after a counter expires (i.e., reaches zero), and a MAC PDU is received.

Sidelink communication for other RATs may be based on different types or modes of resource allocation mechanisms. In another resource allocation mode for a second RAT (which may be referred to herein as “Mode 1” of a second RAT), centralized resource allocation may be provided by a network entity. For example, a network entity may determine resources for sidelink communication and may allocate resources to different wireless devices to use for sidelink transmissions. In this first mode, a wireless device may receive an allocation of sidelink resources from a base station. In a second resource allocation mode (which may be referred to herein as “Mode 2”), distributed resource allocation may be provided. In Mode 2, each wireless device may autonomously determine resources to use for sidelink transmission. In order to coordinate the selection of sidelink resources by individual wireless devices, each wireless device may use a sensing technique to monitor for resource reservations by other sidelink wireless devices and may select resources for sidelink transmissions from unreserved resources. Devices communicating based on sidelink, may determine one or more radio resources in the time and frequency domain that are used by other devices in order to select transmission resources that avoid collisions with other devices.

The sidelink transmission and/or the resource reservation may be periodic or aperiodic, where a wireless device may reserve resources for transmission in a current slot and up to two future slots (discussed below).

Thus, in the second mode (e.g., Mode 2), individual wireless devices may autonomously select resources for sidelink transmission, e.g., without a central entity such as a base station indicating the resources for the device. A first wireless device may reserve the selected resources in order to inform other wireless devices about the resources that the first wireless device intends to use for sidelink transmission(s).

In some examples, the resource selection for sidelink communication may be based on a sensing-based mechanism. For instance, before selecting a resource for a data transmission, a wireless device may previously determine whether resources have been reserved by other wireless devices.

For example, as part of a sensing mechanism for a resource allocation mode 2 of a second RAT, a wireless device may determine (e.g., sense) whether a selected sidelink resource has been reserved by other wireless device(s) before selecting a sidelink resource for a data transmission. If the wireless device determines that the sidelink resource has not been reserved by other wireless devices, the wireless device may use the selected sidelink resource for transmitting the data, e.g., in a PSSCH transmission. The wireless device may estimate or determine which radio resources (e.g., sidelink resources) may be in-use and/or reserved by others by detecting and decoding sidelink control information (SCI) transmitted by other wireless devices. The wireless device may use a sensing-based resource selection algorithm to estimate or determine which radio resources are in-use and/or reserved by others. The wireless device may receive SCI from another wireless device that may include reservation information based on a resource reservation field in the SCI. The wireless device may continuously monitor for (e.g., sense) and decode SCI from peer wireless devices. The SCI may include reservation information, e.g., indicating slots and RBs that a particular wireless device has selected for a future transmission. The wireless device may exclude resources that are used and/or reserved by other wireless devices from a set of candidate resources for sidelink transmission by the wireless device, and the wireless device may select/reserve resources for a sidelink transmission from the resources that are unused and therefore form the set of candidate resources. A wireless device may continuously perform sensing for SCI with resource reservations in order to maintain a set of candidate resources from which the wireless device may select one or more resources for a sidelink transmission. Once the wireless device selects a candidate resource, the wireless device may transmit SCI indicating its own reservation of the resource for a sidelink transmission. The number of resources (e.g., sub-channels per subframe) reserved by the wireless device may depend on the size of data to be transmitted by the wireless device. Although the example is described for a wireless device receiving reservations from another wireless device, the reservations may be received from an RSU or other device communicating based on sidelink.

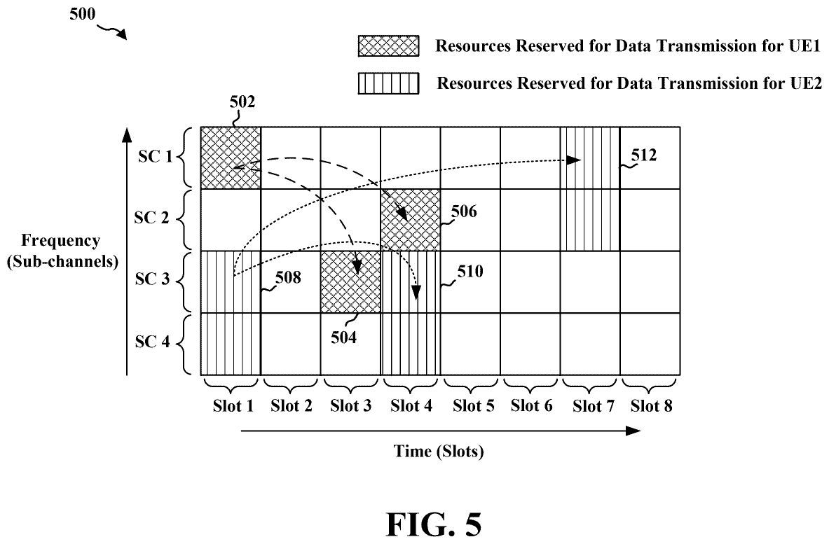

FIG. 5 is an example 500 of time and frequency resources showing reservations for sidelink transmissions. The resources may be in a sidelink resource pool, for example. The resource allocation for each wireless device may be in units of one or more sub-channels in the frequency domain (e.g., sub-channels SCI to SC 4), and may be based on one slot in the time domain. A wireless device may use resources in the current slot to perform an initial transmission, and may reserve resources in future slots for retransmissions. In this example, two different future slots may be reserved by UE1 and UE2 for retransmissions. The resource reservation may be limited to a window of a pre-defined slots and sub-channels, such as an 8 time slots by 4 sub-channels window as shown in example 500, which provides 32 available resource blocks in total. This window may be referred to as a resource selection window.

A first UE (“UE1) may reserve a sub-channel (e.g., SC 1) in a current slot (e.g., slot 1) for its initial data transmission 502, and may reserve additional future slots within the window for data retransmissions (e.g., 504 and 506). For example, UE1 may reserve sub-channels SC 3 at slots 3 and SC 2 at slot 4 for future retransmissions as shown by FIG. 4. UE1 then may transmit information regarding which resources are being used and/or reserved by it to other UE(s). UE1 may do so by including the reservation information in the reservation resource field of the SCI, e.g., a first stage SCI.

FIG. 5 illustrates that a second UE (“UE2”) may reserve resources in sub-channels SC 3 and SC 4 at time slot 1 for data transmission 508, and may reserve data transmission 510 (a retransmission of data transmission 508) at time slot 4 using sub-channels SC 3 and SC 4, and may reserve data transmission 512 (a retransmission of data transmission 508) at time slot 7 using sub-channels SC 1 and SC 2 as shown by FIG. 5. Similarly, UE2 may transmit the resource usage and reservation information to other UE(s), such as using the reservation resource field in SCI.

A third UE may consider resources reserved by other UEs within the resource selection window to select resources to transmit its data. The third UE may first decode SCIs within a time period to identify which resources are available (e.g., candidate resources). For example, the third UE may exclude the resources reserved by UE1 and UE2 and may select other available sub-channels and time slots from the candidate resources for its transmission and retransmissions, which may be based on a number of adjacent sub-channels in which the data (e.g., packet) to be transmitted can fit.

While FIG. 5 illustrates resources being reserved for an initial transmission and two retransmissions, the reservation may be for an initial transmission and a single transmission or for an initial transmission.

A UE may determine an associated signal measurement (such as RSRP) for each resource reservation received by another UE. The UE may consider resources reserved in a transmission for which the UE measures an RSRP below a threshold to be available for use by the UE. A UE may perform signal/channel measurement for a sidelink resource that has been reserved and/or used by other UE(s), such as by measuring the RSRP of the message (e.g., the SCI) that reserves the sidelink resource. Based at least in part on the signal/channel measurement, the UE may consider using/reusing the sidelink resource that has been reserved by other UE(s). For example, the UE may exclude the reserved resources from a candidate resource set if the measured RSRP meets or exceeds the threshold, and the UE may consider a reserved resource to be available if the measured RSRP for the message reserving the resource is below the threshold. The UE may include the resources in the candidate resources set and may use/reuse such reserved resources when the message reserving the resources has an RSRP below the threshold, because the low RSRP indicates that the other UE is distant and a reuse of the resources is less likely to cause interference to that UE. A higher RSRP indicates that the transmitting UE that reserved the resources is potentially closer to the UE and may experience higher levels of interference if the UE selected the same resources.

For example, in a first step, the UE may determine a set of candidate resources (e.g., by monitoring SCI from other UEs and removing resources from the set of candidate resources that are reserved by other UEs in a signal for which the UE measures an RSRP above a threshold value). In a second step, the UE may select N resources for transmissions and/or retransmissions of a TB. As an example, the UE may randomly select the N resources from the set of candidate resources determined in the first step. In a third step, for each transmission, the UE may reserve future time and frequency resources for an initial transmission and up to two retransmissions. The UE may reserve the resources by transmitting SCI indicating the resource reservation. For example, in the example in FIG. 5, the UE may transmit SCI reserving resources for data transmissions 508, 510, and 512.

There may be a timeline for a sensing-based resource selection. For example, a UE may sense and decode the SCI received from other UEs during a sensing window, e.g., a time duration prior to resource selection. Based on the sensing history during the sensing window, a UE may be able to maintain a set of available candidate resources by excluding resources that are reserved by other UEs from the set of candidate resources. A UE may select resources from its set of available candidate resources and transmits SCI reserving the selected resources for sidelink transmission (e.g., a PSSCH transmission) by the UE. There may be a time gap between the UE's selection of the resources and the UE transmitting SCI reserving the resources.

In some aspects, for example when reserving resources using mode 4 of the first RAT or mode 2 of the second RAT, a wireless device, such as a UE, may use semi-persistent scheduling (SPS) to make periodic reservations for sidelink resources. On a per resource pool basis, a reservation of a sidelink resource for a transmission of a TB may reserve a number of periodic sidelink resources. For example, a wireless device may use an SCI associated with a first TB to reserve a sidelink resource for an initial transmission of a second TB. Such periodic reservations may be used for retransmissions of the initial transmission. The SCI may include a period, such as every 100 ms, which may signal an application of the same reservation with respect to resources within a window at subsequent periods. The SCI may use a number of bits, such as one, two, three, or four bits to indicate the period. The number of periodic reservations may be limited by a threshold, such as N_{MAX}. For example, a reservation for a TB at time 0 ms may signal a periodic reservation (e.g., at 100, 200, 300, 400, 500, 600, 700, 800, 900, and 1000 ms.) Such periodic values may be configured or preconfigured in any suitable manner, for example via RRC configuration from a base station, pre-programed in factory, or via a pervious transmission. In some aspects, the number of periodic reservations may be one, two, or more. In some aspects, the wireless device may measure an average RSSI measurement over a number of periods to rank resources by the highest and lowest RSSI, and may select a candidate resource with the lowest RSSI.

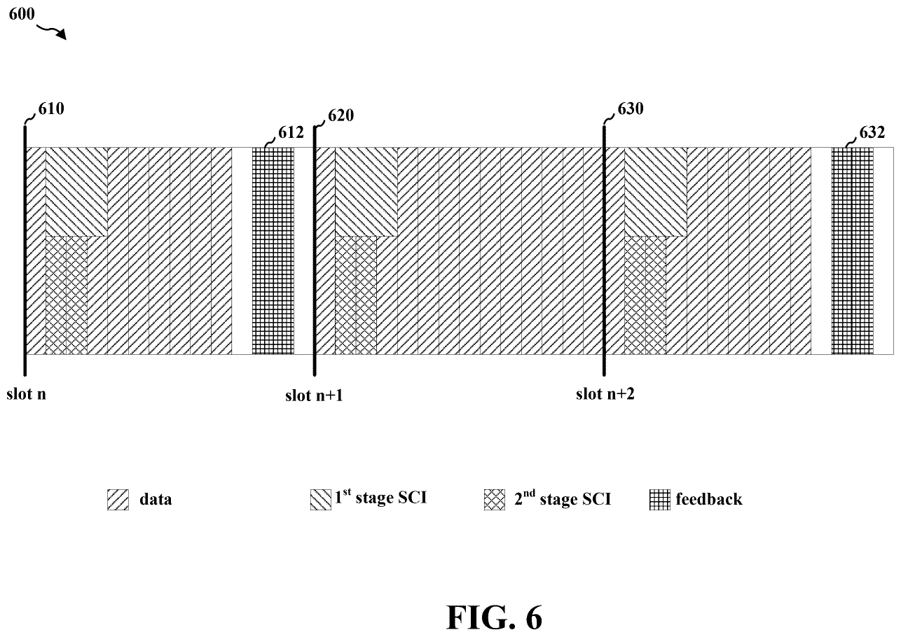

FIG. 6 is an example 600 of SCI, data, and feedback resources showing reservations for sidelink transmissions. The feedback resources may be system wide, and may be configured, or preconfigured, with a number of slots, such as 1, 2, or 4 slots. Here, two slots have been configured, slot 610 at time n, and slot 630 at time n+2. Slot 620 may be disposed between slot 610 and slot 630. Where a feedback resource is configured, three orthogonal frequency division multiplexing (ODFM) symbols may be occupied where a feedback resource is configured. For example, feedback resource 612 may be precluded by a gap symbol, followed by the two physical sidelink feedback channel (PSFCH) symbols of the feedback resource 612. Similarly, feedback resource 632 may be precluded by a gap symbol, followed by the two PSFCH symbols of the feedback resource 632. The number of PRBs for a PSFCH may be configured or preconfigured.

A PUCCH format 0 on one RB may have a hybrid automatic repeat request (HARQ) acknowledgement (HARQ-ACK) information for a single PSSCH transmission. A PSFCH format 0 sequence may be repeated on two PSFCH symbols. A PSFCH may be unicast or groupcast. In one aspect, a PSFCH for unicast may have a one bit ACK/NACK. In another aspect, a PSFCH for groupcast may have a first feedback mode where a receiving wireless device may transmit NACK feedback, and a second feedback mode where a receiving wireless device may transmit an ACK or a NACK feedback.

A PSFCH may be multiplexed in frequency and/or code domain. In one aspect, a frequency resource may be a PRB for a PSFCH. In another aspect, a code resource may be a cyclic shift of a base sequence in one PRB. A base sequence may be configured or preconfigured for one or more resource pools. A wireless device may configure a number of PRBs based on a PSSCH resource index that defines how many PRBs each PSSCH resource may be mapped to. For example, each a PSSCH resource index may define each PSSCH resource (e.g., one subchannel/slot) to be mapped to a number of PRBs having value Z.

Wireless devices may be configured to use one or more radio access technologies (RATs) to transmit data, such as sidelink transmissions. Each RAT may have different configurations or attributes. In one aspect, a first RAT may have a low rate of communication to provide basic safety messages while a second RAT may have a higher rate of communication to provide advanced safety and autonomy support with stringent conditions or specifications. The first RAT may have periodic traffic designated to be transmitted in accordance with an RSVP. A receiver of a periodic transmission associated with a periodic RAT may be able to predict when new packets will be transmitted from the same transmitter due to such periodicity. Some wireless devices may be configured to transmit and receive using one RAT, while other wireless devices may be configured to transmit and receive using a plurality of RATs.

In another example, a wireless device may use a first RAT to provide advanced safety messages and a second RAT to provide basic safety messages. While wireless devices may be able to avoid direct overlap of resources via a sidelink reservation system within the same RAT, channels reserved for a first RAT may be overlapping or adjacent to channels reserved for a second RAT such that transmissions using a first RAT may interfere with transmissions using a second RAT.

Where two or more distributed communication technologies, such as RATs, coexist in adjacent channels, interference may occur when a first wireless device transmits a first transmission from a first location using a first RAT and a second wireless device transmits a second transmission from a second location using a second RAT, where the locations are far apart. In one aspect, a transmission from a first wireless device using a first RAT may cause enough out of band interference to disrupt a transmission from a second wireless device using a second RAT that is further away than the first wireless device. Added coordination between resource allocation for transmissions using a first RAT and resource allocation for transmissions using a second RAT may be able to reduce such out-of-band interference.

In one aspect, a first wireless device may be configured to receive a first indication of a set of first slots associated with a first set of V2X transmissions from a second wireless device. The first set of V2X transmissions may be associated with a first RAT. The first wireless device may be configured to communicate a second indication of a set of second slots associated with second set of V2X transmissions. The second set of V2X transmissions may be subsequent to the first set of V2X transmissions. The second set of V2X transmissions may be associated with the first RAT. The second indication may be based on at least one of: (1) a reference signal received power (RSRP) associated with the first set of V2X transmissions being greater than an RSRP threshold or (2) a distance between the first wireless device and the second wireless device being less than a threshold distance.

The indication may be obtained by a third wireless device. The third wireless device may be configured to obtain an indication of a set of second slots associated with a second set of V2X transmissions. The second set of V2X transmissions may be subsequent to a first set of V2X transmissions associated with a set of first slots. The set of first slots and the set of second slots may be associated with a first resource set. The first set of V2X transmissions and the second set of V2X transmissions may be between a first wireless device and a second wireless device. The first set of V2X transmissions may be associated with a first RAT and the second set of V2X transmissions may be associated with the first RAT. The indication may be based on at least one of: (1) an RSRP associated with the first set of V2X transmissions being greater than an RSRP threshold or (2) a distance between the first wireless device and the second wireless device being less than a threshold distance. The third wireless device may be configured to refrain from transmitting a third V2X transmission in the set of second slots that interfere with the first reserved resource set associated with the second set of V2X transmissions based on the indication. The third V2X transmission may be associated with a second RAT different from the first RAT.

A candidate resource set may be a set of resources defined in a resource grid. Such resources may be selected by a first wireless device or a second wireless device. A first V2X transmission associated with a first RAT and a second V2X transmission associated with a second RAT may be transmitted on resources selected from candidate resource sets. The selected resources may coexist in the same band, but may operate on different channels within the same frequency band. Since the selected resources may belong to adjacent channels, transmissions of the first RAT that use resources from one resource set that belong to a first channel may cause out of band interference to disrupt receiving a transmission of the second RAT that use resources from one another resource set that belong to a second channel if the first channel and the second channel are adjacent to one another. A transmitting wireless device may be configured to schedule its transmissions using a first RAT around reception slots or around reception resources expected to be used to receive transmissions using a second RAT. Such scheduling mechanisms may be particularly useful where the transmission using one RAT may interfere with a potential reception on resources of the candidate resource set using another RAT. In another aspect, a wireless device may reselect a different period of time for the first transmission so that it is not transmitted during a period of time that overlaps with the second transmission, may reselect alternative resources for the first transmission that do not overlap with, or are not adjacent to, the candidate resources used by the second transmission, or may refrain from transmitting the first transmission. Reselection of the alternative resources may occur before or after transmitting an indication to transmit the first transmission using the initial resources that may interfere with the candidate resources used by the second transmission.

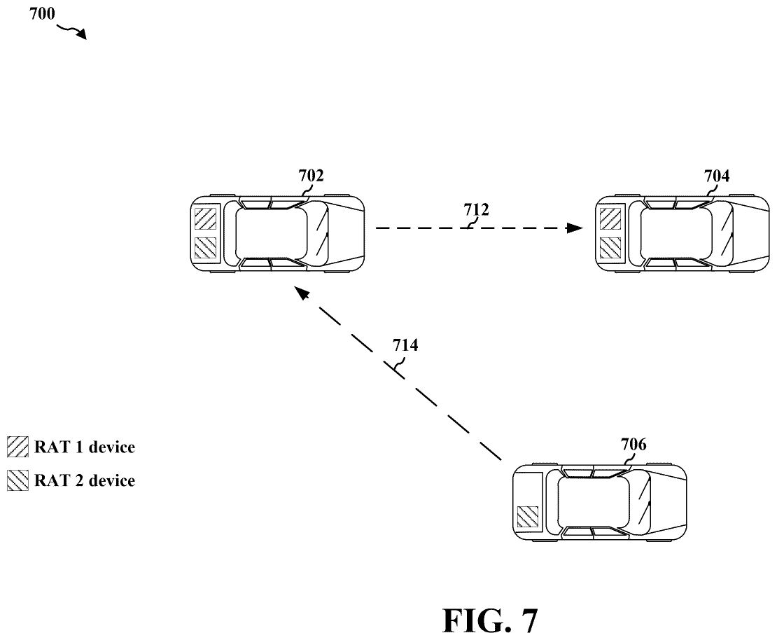

FIG. 7 illustrates an example 700 of V2X communication between a wireless device 702, a wireless device 704, and a wireless device 706. The communication may be based on any D2D communication link such as one or more sidelink channels. The wireless device 702 may have two wireless devices, a RAT 1 device configured to transmit and receive D2D transmissions using a first RAT, and a RAT 2 device configured to transmit and receive D2D transmissions using a second RAT different from the first RAT. The RAT I device and the RAT 2 device of the wireless device 702 may be two components of a single wireless device, such as two boards in a mobile device. The RAT 1 device and the RAT 2 device of the wireless device 702 may be configured to communicate with one another using a wired connection, such as a wire or a communication bus. The RAT 1 device and the RAT 2 device of the wireless device 702 may be configured to communicate with one another using a wireless connection, such as via a Wi-Fi connection or a Bluetooth connection.

The RAT 1 device may be, for example, an NR V2X device configured to support dynamic periodicity, with a plurality of numerologies where each slot duration may be different. The RAT 1 device may be configured to schedule one or more PSFCH feedback resources for a transmission, and may be configured to retransmit a failed transmission many more times than the RAT 2 device (e.g., 32 retransmission times for the RAT 1 device verses one retransmission time for the RAT 2 device). The RAT 2 device may be, for example, an LTE V2X device configured to support semi-static or a fixed periodicity in accordance with an RSVP value (e.g., 100 ms) that may have a lower duty cycle than the RAT 1 device, and transmissions of the RAT 2 device may have a smaller payload than the RAT 1 device. The RAT 2 device may not be configured to schedule one or more PSFCH feedback resources for a transmission, and may not be configured to retransmit a transmission as many times as the RAT 1 device.

The wireless device 704 may have both a RAT 1 device and a RAT 2 device. The wireless device 706 may have a RAT 2 device, but may not have a RAT 1 device. In other words, the wireless device 702 and 704 may be configured to transmit and receive transmissions using RAT 1 or RAT 2, while the wireless device 706 may be configured to transmit and receive transmissions using RAT 2 and not using RAT 1. The wireless device 702 may be configured to transmit a transmission 712 associated with RAT 1 to the wireless device 704. The transmission 712 may be transmitted using the RAT 1 device of the wireless device 702 and may be received using the RAT 1 device of the wireless device 704. The wireless device 706 may be configured to transmit a transmission 714 associated with RAT 2 to the wireless device 702. The transmission 714 may be transmitted using the RAT 2 device of the wireless device 706 and may be received using the RAT 2 device of the wireless device 702.

The transmission 712 associated with RAT 1 may interfere with receiving the transmission 714 associated with RAT 2. In other words, the RAT 1 device of the wireless device 702 may act as a strong blocker when it transmits the transmission 712 associated with RAT 1 that may block the transmission 714 associated with RAT 2 from being successfully received by the RAT 2 device of the wireless device 702. The wireless device 702 may be configured to protect one or more transmissions received from the wireless device 706 using the RAT 2 device. For example, the wireless device 702 may be configured to protect transmissions having high priority packets or packets from nearby vehicles using the RAT 2 device. In the other direction, the wireless device 702 may be configured to prioritize important transmissions of the RAT 1 device.

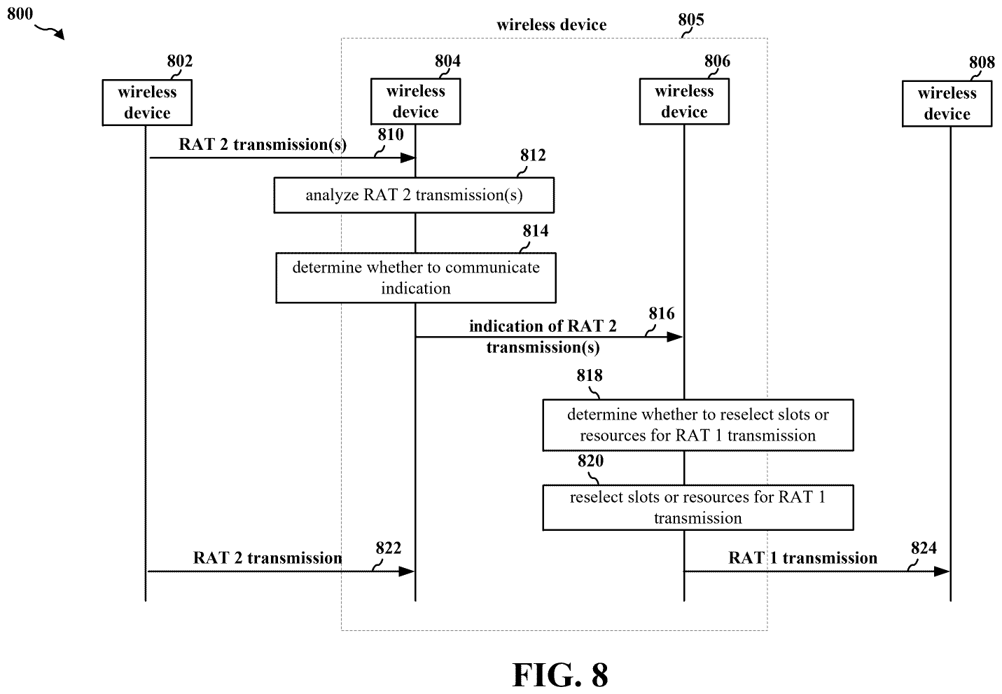

FIG. 8 illustrates a connection flow diagram 800 for a plurality of wireless devices 802, 804, 806, and 808. The wireless devices 804 and 806 may be components of a wireless device 805. In one aspect, the wireless device 802 may be the wireless device 706 in FIG. 7, the wireless device 808 may be the wireless device 704 in FIG. 7, the wireless device 805 may be the wireless device 702 in FIG. 7, the wireless device 804 may be the RAT 2 device of the wireless device 702 in FIG. 7, and the wireless device 806 may be the RAT 1 device of the wireless device 702 in FIG. 7. In other words, the wireless device 802 and the wireless device 804 may be configured to transmit RAT 2 transmissions with one another, the wireless device 806 and the wireless device 808 may be configured to transmit RAT 1 transmissions with one another, and the wireless device 804 and the wireless device 806 may be configured to communicate with one another using a wired connection, such as a backhaul connection or a bus. The RAT 1 device may be, for example, an NR V2X transceiver and the RAT 2 device may be, for example, an LTE V2X transceiver.

The wireless device 802 may be configured to transmit a set of RAT 2 transmissions 810 to the wireless device 804. At 812, the wireless device 804 may be configured to analyze the set of RAT 2 transmissions 810. For example, the wireless device 804 may be configured to decode a control (e.g., SCI) of the set of RAT 2 transmissions 810. The decoded control may have, for example, a priority indication of the set of RAT 2 transmissions 810, or a periodicity of the set of RAT 2 transmissions 810. The wireless device 802 may also measure a reference signal received power (RSRP) of the RAT 2 transmission 810. A priority indication may include, for example, a proximity services (ProSe) per packet priority (PPPP). In some aspects, the wireless device 804 may measure an RSRP of the set of RAT 2 transmissions 810. The wireless device 804 may be configured to decode data of the set of RAT 2 transmissions 810. The decoded data may include a message having a position indication associated with the wireless device 802, for example GNSS coordinates or a zone indicator. Such a message may be, for example, a basic safety message (BSM) or a connected and automated mobility (CAM) message. A BSM or a CAM message may have position data associated with the wireless device 802, for example GNSS coordinates. The wireless device 804 may use the position data to estimate a distance between the wireless device 804 and the wireless device 802, or the wireless device 805 and the wireless device 802.

At 814, the wireless device 804 may be configured to determine whether to communicate an indication to protect an incoming transmission, such as the RAT 2 transmission 822, to the wireless device 806. The wireless device 804 may be configured to communicate the indication to the wireless device 806 based on an environmental variable trigger. In one aspect, the wireless device 804 may be configured to communicate an indication to the wireless device 806 if an RSRP of the set of RAT 2 transmissions 810 is equal to or larger than an RSRP threshold value. In another aspect, the wireless device 804 may be configured to communicate an indication to the wireless device 806 if an estimated distance between the wireless device 804 and the wireless device 802, or the wireless device 805 and the wireless device 802, is equal or smaller than a distance threshold value. The wireless device 804 may select the RSRP threshold value or the distance threshold value based on a priority indication of the set of RAT 2 transmissions 810. Such values may be selected from a table saved to a memory accessible by the wireless device 804. For example, the wireless device 804 may select a higher RSRP threshold value or a lower distance threshold value for a higher priority indication and may select a lower RSRP threshold value or a higher distance threshold value for a lower priority indication. In some aspects, the wireless device 804 may select the RSRP threshold value or the distance threshold value based on a congestion indicator, such as a measured channel busy ratio (CBR) or a number of packets received within a time period. For example, the wireless device 804 may select a higher RSRP threshold value or a lower distance threshold value for a higher CBR or number of packets received within a time period and may select a lower RSRP threshold value or a higher distance threshold value for a lower CBR or number of packets received within a time period.

The wireless device 804 may transmit the indication 816 of the set of RAT 2 transmissions to the wireless device 806. The indication 816 may include the slots of the RAT 2 transmission 822, or of a periodic interval for a set of RAT 2 transmissions, and the RAT 2 transmission 822 may be a part of the set of periodic RAT 2 transmissions. In another aspect, the indication 816 of the set of RAT 2 transmissions may include one or more attributes of the RAT 2 transmission 822. For example, the indication 816 may include at least one of an RSVP of the RAT 2 transmission 822, a retransmission interval of the RAT 2 transmission 822 (e.g., TDRI), a periodicity of the RAT 2 transmission 822 (e.g., an RSVP), a candidate resource set of the RAT 2 transmission 822, a set of slots associated with the RAT 2 transmission 822, or a resource associated with the RAT 2 transmission 822. In some aspects, one or more attributes of the RAT 2 transmission 822 may be shared by the RAT 1 transmission 810. Thus, the indication 816 of the set of RAT 2 transmissions may include one or more attributes of the RAT 1 transmission 810 that are shared with the RAT 2 transmission 822.

In some aspects, the wireless device 804 may assume a periodicity or an RSVP of the wireless device 802 to transmit transmissions, such as the set of RAT 2 transmissions 810, to be fixed (e.g., every 100 ms). In some aspects, the periodicity (e.g., RSVP) of the set of RAT 2 transmissions 810 may be changed, for example when congestion is detected by the wireless device 802. At 814, the wireless device 804 may obtain an indication of congestion, and, in response, may alter one or more attributes of the indication 816 of the set of RAT 2 transmissions transmitted to the wireless device 806. In some aspects, the wireless device 804 may obtain the indication of congestion from a wireless device, such as an RSU or a network entity. For example, the wireless device 804 may receive a congestion level indication from an RSU or a network entity, or may measure a CBR as an indication of a congestion level. In other aspects, the wireless device 804 may obtain the indication of congestion by counting a number of packets received within a time period. When counting a number of packets received within a time period, the wireless device 804 may remove duplicates, for example if a plurality packets are received from the same transmitter. If the wireless device 804 receives a number of packets within a time period that meets or exceeds a threshold value, the wireless device 804 may determine that a congestion event has occurred. In response to obtaining an indication of congestion, the wireless device 804 may estimate a new periodicity of the wireless device 802, for example by analyzing a plurality of RAT 2 transmissions received from the wireless device 802. If the wireless device 804 is unable to estimate the new periodicity, the wireless device 804 may refrain from transmitting the indication 816 of the set of RAT 2 transmissions to the wireless device 806.

The wireless device 806 may have selected resources for the RAT 1 transmission to be transmitted to the wireless device 808 during some future slots. At 818, the wireless device 806 may determine whether to reselect resources for a RAT 1 transmission to protect the RAT 2 transmission 822. The RAT 1 transmission may have a set of slots that overlap with a set of slots of the RAT 2 transmission 822. The RAT 1 transmission may use a frequency band or channel that overlaps with a set of candidate resources of the RAT 2 transmission 822, or is adjacent to the set of candidate resources of the RAT 2 transmission 822. Reselecting resources for the RAT 1 transmission may include, for example, reselecting resources for the RAT 1 transmission to be transmitted during a time period that does not overlap with the RAT 2 transmission 822, by reselecting resources for the RAT 1 transmission to be transmitted using a frequency band or channel that does not interfere with the candidate resource set of the RAT 2 transmission 822 (e.g., is not adjacent to the candidate resource set of the RAT 2 transmission 822) during the same time period that does overlap with the RAT 2 transmission 822, reselecting resources for the RAT 1 transmission to be transmitted during a time period that does not overlap with the RAT 2 transmission 822 and by reselecting resources of a frequency band or channel that does not interfere with the candidate resource set of the RAT 2 transmission 822, or by refraining from transmitting the RAT 1 transmission.

The wireless device 806 may be configured to reselect resources for the RAT 1 transmission 824 before or after an indication to transmit the RAT 1 transmission 824 has been transmitted. In one aspect, the wireless device 806 may transmit an SCI scheduling the RAT 1 transmission 824 prior to transmitting the RAT 1 transmission 824. If the wireless device 806 reselects resources for the RAT 1 transmission 824 before transmitting the SCI, the wireless device 806 may update the SCI with the reselected resources for scheduling the RAT 1 transmission 824. If the wireless device 806 reselects resources for the RAT 1 transmission 824 after transmitting the SCI, the wireless device 806 may transmit the RAT I transmission 824 with the reselected resources, violating its own schedule, but the wireless device 808 may still receive the RAT 1 transmission 824 successfully as it may be configured to monitor transmissions during the same slots associated with the pre-selected resources.

At 820, the wireless device 806 may reselect resources for the RAT 1 transmission. In one aspect, the wireless device 806 may perform an SPS resource reselection to select resources for the RAT 1 transmission 824 that do not overlap with reported slots of the RAT 2 transmission 822. In another aspect, the wireless device 806 may perform a resource pre-emption to select resources for the RAT 1 transmission 824 that do not overlap with reported slots of the RAT 2 transmission 822. The selected resources may include a frequency band or channel that is not adjacent to the candidate resource set of the RAT 2 transmission 822. The wireless device 806 may reselect resources for the RAT 1 transmission by dropping the data transmission such that the RAT 1 transmission 824 is not transmitted (i.e., selecting zero slots and resources). The wireless device 806 may reselect resources for the RAT 1 transmission by dropping the transmission if the transmission is a PSFCH transmission. The wireless device 806 may determine whether to drop a data transmission based on at least one of a feedback mode of the RAT 1 transmission, a cast type (e.g., unicast, broadcast, multi-cast) of the RAT 1 transmission, a priority of the RAT 1 transmission, or a feedback distance of the RAT 1 transmission.

The wireless device 806 may be configured to determine whether to reselect resources for the RAT 1 transmission based on a packet priority of the RAT 1 transmission, a remaining packet delay budget (PDB) of the RAT 1 transmission, or a number of retransmissions left for the RAT 1 transmission. In one aspect, if the packet priority of the RAT 1 transmission is equal to or above a threshold value, the wireless device 806 may not reselect resources for the RAT 1 transmission. In another aspect, if the remaining PDB of the RAT 1 transmission or a number of retransmissions left for the RAT 1 transmission is equal to or below a threshold value, the wireless device 806 may not reselect resources for the RAT 1 transmission.

The wireless device 802 may transmit the RAT 2 transmission 822 to the wireless device 804. The wireless device 806 may transmit the RAT 1 transmission 824 to the wireless device 808. As a result of the reselection of resources of the RAT 1 transmission at 820, the RAT 1 transmission 824 may not interfere with a successful receipt of the RAT 2 transmission 822.

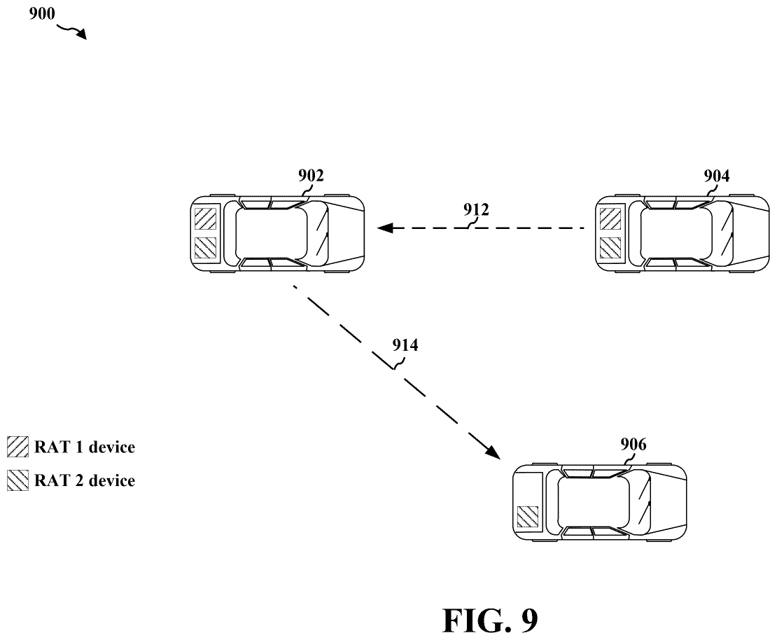

FIG. 9 illustrates an example 900 of V2X communication between a wireless device 902, a wireless device 904, and a wireless device 906, similar to the wireless device 702, the wireless device 704, and the wireless device 706 in FIG. 7, respectively. The wireless device 902 may have both a RAT 1 device and a RAT 2 device. The wireless device 904 may have both a RAT 1 device and a RAT 2 device. The wireless device 906 may have a RAT 2 device, but may not have a RAT 1 device. In other words, the wireless device 902 and 904 may be configured to transmit and receive transmissions using RAT 1 or RAT 2, while the wireless device 906 may be configured to transmit and receive transmissions using RAT 2 and not using RAT 1. The wireless device 904 may be configured to transmit a transmission 912 associated with RAT 1 to the wireless device 902. The transmission 912 may be transmitted using the RAT 1 device of the wireless device 904 and may be received using the RAT 1 device of the wireless device 902. The wireless device 902 may be configured to transmit a transmission 914 associated with RAT 2 to the wireless device 906. The transmission 914 may be transmitted using the RAT 2 device of the wireless device 902 and may be received using the RAT 2 device of the wireless device 906.

The transmission 914 associated with RAT 2 may interfere with receiving the transmission 912 associated with RAT 1. In other words, the RAT 2 device of the wireless device 902 may act as a strong blocker when it transmits the transmission 914 associated with RAT 2 that may block the transmission 912 associated with RAT 1 from being successfully received by the RAT 1 device of the wireless device 902. The wireless device 902 may be configured to protect one or more transmissions received from the wireless device 904 using the RAT 1 device. For example, the wireless device 902 may be configured to protect transmissions having high priority packets or packets from nearby vehicles using the RAT 1 device. In the other direction, the wireless device 902 may be configured to prioritize important transmissions of the RAT 1 device.

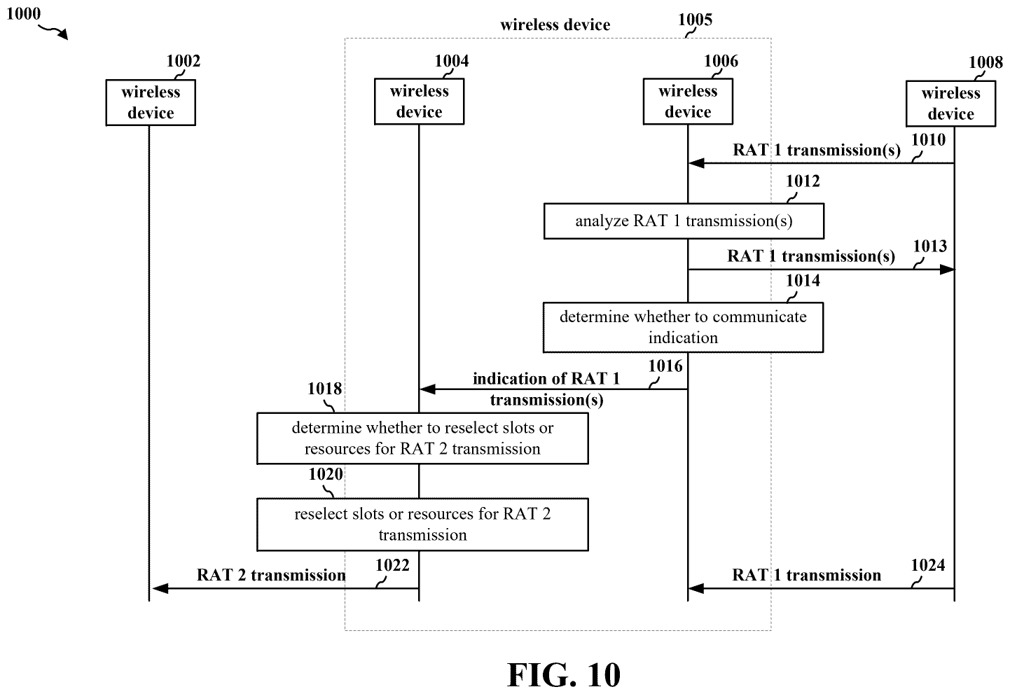

FIG. 10 illustrates a connection flow diagram 1000 for a plurality of wireless devices 1002, 1004, 1006, and 1008. The wireless devices 1004 and 1006 may be components of a wireless device 1005. In one aspect, the wireless device 1002 may be the wireless device 906 in FIG. 9, the wireless device 1008 may be the wireless device 904 in FIG. 9, the wireless device 1005 may be the wireless device 902 in FIG. 9, the wireless device 1004 may be the RAT 2 device of the wireless device 902 in FIG. 9, and the wireless device 1006 may be the RAT 1 device of the wireless device 902 in FIG. 9. In other words, the wireless device 1002 and the wireless device 1004 may be configured to transmit RAT 2 transmissions with one another, the wireless device 1006 and the wireless device 1008 may be configured to transmit RAT 1 transmissions with one another, and the wireless device 1004 and the wireless device 1006 may be configured to communicate with one another using a wired connection, such as a backhaul connection or a bus. The RAT 1 device may be, for example, an NR V2X transceiver and the RAT 2 device may be, for example, an LTE V2X transceiver.

The wireless device 1008 may be configured to transmit a set of RAT 1 transmissions 1010 to the wireless device 1006. At 1012, the wireless device 1006 may be configured to analyze the set of RAT 1 transmissions 1010. For example, the wireless device 1006 may be configured to decode a control (e.g., SCI) of the set of RAT 1 transmissions 1010. The decoded control may have, for example, a priority indication of the set of RAT 1 transmissions 1010, a periodicity of the set of RAT 1 transmissions 1010 (e.g., an RSVP), one or more future resources for potential retransmissions of a same packet of the set of RAT 1 transmissions 1010, a cast type of the set of RAT 1 transmissions 1010, or a feedback distance of the set of RAT 1 transmissions 1010 (e.g., a maximum communication range). In some aspects, the wireless device 1006 may measure an RSRP of the set of RAT 1 transmissions 1010. The wireless device 1006 may be configured to decode data of the set of RAT 1 transmissions 1010. The decoded data may have position data associated with the wireless device 1008, for example GNSS coordinates. The wireless device 1006 may receive zone information with the set of RAT 1 transmissions 1010. The zone information may be used to provide position data associated with the wireless device 1008. The wireless device 1006 may use the position data to estimate a distance between the wireless device 1006 and the wireless device 1008, or the wireless device 1005 and the wireless device 1008.

The wireless device 1006 may transmit a set of RAT 1 transmissions 1013 to the wireless device 1008. The wireless device 1006 may schedule one or more PSFCH resources for the set of RAT 1 transmissions 1013, such that the wireless device 1006 knows when to expect a PSFCH transmission from the wireless device 1008 to the wireless device 1006. The wireless device 1006 may be configured to schedule the one or more PSFCH resources for the set of RAT 1 transmissions 1013 based on a one to one mapping relationship with the resource used to transmit the set of RAT 1 transmissions 1013. In another aspect, the wireless device 1006 may indicate the scheduling of the one or more PSFCH resources in the set of RAT 1 transmissions 1013. The wireless device 1006 may be able to derive one or more slots where it expects to receive a PSFCH for the set of RAT 1 transmissions 1013.

At 1014, the wireless device 1006 may be configured to determine whether to communicate an indication to protect an incoming transmission, such as the RAT 2 transmission 1022, to the wireless device 1004. The wireless device 1006 may be configured to communicate the indication to the wireless device 1004 based on an environmental variable trigger. In one aspect, the wireless device 1006 may be configured to communicate an indication to the wireless device 1004 if an RSRP of the set of RAT 1 transmissions 1010 is equal to or larger than an RSRP threshold value. In another aspect, the wireless device 1006 may be configured to communicate an indication to the wireless device 1004 if an estimated distance between the wireless device 1006 and the wireless device 1008, or the wireless device 1005 and the wireless device 1008, is equal or smaller than a distance threshold value. The wireless device 1006 may select the RSRP threshold value or the distance threshold value based on a priority indication of the set of RAT 1 transmissions 1010, a packet priority of the set of RAT 1 transmissions 1010, a cast type of the set of RAT 1 transmissions 1010, or a feedback distance of the set of RAT 1 transmissions 1010 (e.g., a maximum communication range). Such values may be selected from a table saved to a memory accessible by the wireless device 1004. For example, the wireless device 1006 may select a higher RSRP threshold value or a lower distance threshold value for a first value and may select a lower RSRP threshold value or a higher distance threshold value for a second value. In some aspects, the wireless device 1006 may select the RSRP threshold value or the distance threshold value based on a congestion indicator, such as a CBR or a number of packets received within a time period. For example, the wireless device 1006 may select a higher RSRP threshold value or a lower distance threshold value for a higher CBR or number of packets received within a time period and may select a lower RSRP threshold value or a higher distance threshold value for a lower CBR or number of packets received within a time period.

The wireless device 1006 may transmit the indication 1016 of the set of RAT 1 transmissions to the wireless device 1004. In one aspect, the indication 1016 may be a set of slots where the wireless device 1006 is expected to receive the one or more RAT 1 transmissions. In another aspect, the indication 1016 of the set of RAT 1 transmissions may include one or more attributes of the RAT 1 transmission 1024. For example, the indication 1016 may include at least one of an RSVP of the RAT 1 transmission 1024, a retransmission interval of the RAT 1 transmission 1024 (e.g., TDRI), a periodicity of the RAT 1 transmission 1024 (e.g., an RSVP), a candidate resource set of the RAT 1 transmission 1024, a set of slots associated with the RAT 2 transmission 1024, a resource associated with the RAT 1 transmission 1024, or a PSFCH resource associated with RAT 1 transmission 1024. In some aspects, one or more attributes of the RAT 1 transmission 1024 may be shared by the set of RAT 1 transmissions 1010. Thus, the indication 1016 of the set of RAT 1 transmissions may include one or more attributes of the set of RAT 1 transmissions 1010 that are shared with the RAT 1 transmission 1024.

In some aspects, the wireless device 1004 may assume a periodicity or an RSVP of the wireless device 1002 to transmit transmissions, such as the RAT 2 transmission 1010, to be fixed (e.g., every 100 ms). In some aspects, the periodicity (e.g., an RSVP) of the RAT 2 transmission 1010 may be changed, for example when congestion is detected by the wireless device 1002. At 1014, the wireless device 1006 may obtain an indication of congestion. In some aspects, the wireless device 1006 may obtain the indication of congestion from a wireless device, such as an RSU or a network entity. In another example, the wireless device 1006 may measure a CBR as an indication for congestion level. In other aspects, the wireless device 1006 may obtain the indication of congestion by counting a number of packets received within a time period. When counting a number of packets received within a time period, the wireless device 1006 may remove duplicates, for example if a plurality of packets is received from of the same transmitter. If the wireless device 1004 receives a number of packets within a time period that meets or exceeds a threshold value, the wireless device 1004 may determine that a congestion event has occurred. In response to obtaining an indication of congestion, the wireless device 1004 may estimate a new periodicity of the wireless device 1008, for example by analyzing a plurality of RAT 12 transmissions received from the wireless device 1008. If the wireless device 1006 is unable to estimate the new periodicity, the wireless device 1006 may refrain from transmitting the indication 1016 of the set of RAT 1 transmissions to the wireless device 1004.

The wireless device 1006 may have selected resources for the RAT 1 transmission to be transmitted to the wireless device 1008 during some future slots. At 1018, the wireless device 1004 may determine whether to reselect slots or resources for a RAT 2 transmission to protect the RAT 1 transmission 1024. The RAT 2 transmission may have a set of slots that overlap with a set of slots of the RAT 1 transmission 1024. Reselecting resources for the RAT 2 transmission may include, for example, reselecting resources for the RAT 2 transmission to be transmitted during a time period that does not overlap with the RAT 1 transmission 1024, by reselecting resources for the RAT 2 transmission to be transmitted using a frequency band or channel that does not interfere with the candidate resource set of the RAT 1 transmission 1024 (e.g., is not adjacent to the candidate resource set of the RAT 1 transmission 1024) during the same time period that does overlap with the RAT 1 transmission 1024, by reselecting resources for the RAT 2 transmission to be transmitted during a time period that does not overlap with the RAT 1 transmission 1024 and by reselecting resources using a frequency band or channel that does not interfere with the candidate resource set of the RAT 1 transmission 1024, or by refraining from transmitting the RAT 2 transmission.

The wireless device 1006 may be configured to reselect resources for the RAT 1 transmission 1024 before or after an indication to transmit the RAT 1 transmission 1024 has been transmitted. In one aspect, the wireless device 1006 may transmit an SCI scheduling the RAT 1 transmission 1024 prior to transmitting the RAT 1 transmission 1024. If the wireless device 1006 reselects resources for the RAT 1 transmission 1024 before transmitting the SCI, the wireless device 1006 may update the SCI with the reselected resources for scheduling the RAT 1 transmission 1024. If the wireless device 1006 reselects resources for the RAT 1 transmission 1024 after transmitting the SCI, the wireless device 1006 may transmit the RAT 1 transmission 1024 with the reselected resources, violating its own schedule, but the wireless device 1008 may still receive the RAT 1 transmission 1024 successfully as it may be configured to monitor transmissions during the same pre-selected slots.

At 1020, the wireless device 1004 may reselect resources for the RAT 2 transmission. In one aspect, the wireless device 1004 may perform an SPS resource reselection to select resources for the RAT 2 transmission 1022 that do not overlap with reported slots of the RAT 2 transmission 1022. In another aspect, the wireless device 1004 may perform a resource pre-emption to select resources for the RAT 2 transmission 1022 that do not overlap with reported resources of the RAT 1 transmission 1024. The selected resources may include a frequency band or channel that is not adjacent to the candidate resource set of the RAT 1 transmission 1024. The wireless device 1004 may reschedule the RAT 2 transmission by dropping the data transmission such that the RAT 2 transmission 1022 is not transmitted. The wireless device 1004 may reselect resources for the RAT 2 transmission by dropping the data transmission if the data transmission is a PSFCH transmission. The wireless device 1004 may determine whether to drop a data transmission based on at least one of a feedback mode of the RAT 2 transmission, a cast type (e.g., unicast, broadcast, multi-cast) of the RAT 2 transmission, a priority of the RAT 2 transmission, or a feedback distance of the RAT 2 transmission. In some aspects, the wireless device 1004 may reselect slots or resources for the RAT 2 transmission 1022 and no other transmissions. For example, if the RAT 2 transmission 1022 is part of a set of periodic transmissions, the wireless device 1004 may reselect slots or resources for the RAT 2 transmission 1022, but no other transmissions of the set of periodic transmissions. In other aspects, the wireless device 1004 may reselect resources for a set of transmissions where the RAT 2 transmission 1022 is one of the set of transmissions. For example, if the RAT 2 transmission 1022 is part of a set of periodic transmissions, the wireless device 1004 may reselect resources for the set of periodic transmissions so that none of the set of periodic transmissions may interfere with the set of RAT 1 transmissions 1010.

The wireless device 1004 may be configured to determine whether to reselect resources for the RAT 2 transmission based on a packet priority of the RAT 2 transmission, a remaining PDB of the RAT 2 transmission, or a number of retransmissions left for the RAT 2 transmission. In one aspect, if the packet priority of the RAT 2 transmission is equal to or above a threshold value, the wireless device 1004 may not reselect slots or resources for the RAT 2 transmission. In another aspect, if the remaining PDB of the RAT 2 transmission or a number of retransmissions left for the RAT 2 transmission is equal to or below a threshold value, the wireless device 1004 may not reselect resources for the RAT 2 transmission.

The wireless device 1004 may transmit the RAT 2 transmission 1022 to the wireless device 1002. The wireless device 1008 may transmit the RAT 1 transmission 1024 to the wireless device 1006. As a result of the reselection of resources of the RAT 2 transmission at 1020, the RAT 2 transmission 1022 may not interfere with a successful receipt of the RAT 1 transmission 1024.

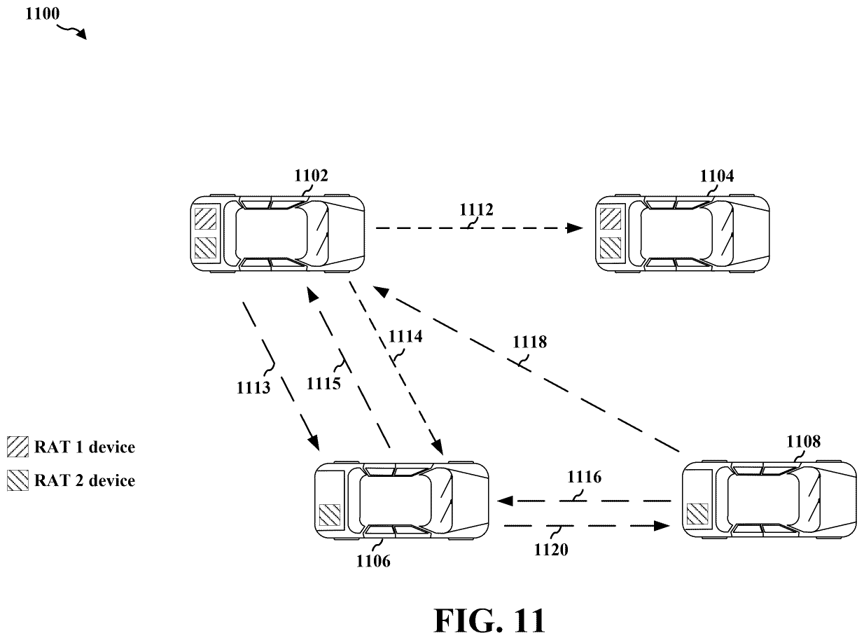

FIG. 11 illustrates an example 1100 of V2X communication between a wireless device 1102, a wireless device 1104, a wireless device 1106, and a wireless device 1108. The wireless device 1102, wireless device 1104, and wireless device 1108 may be similar to the wireless device 702, the wireless device 704, and the wireless device 706 in FIG. 7, respectively. The wireless device 1106 may be similar to the wireless device 706 in FIG. 7. The wireless device 1102 and the wireless device 1104 may each have both a RAT 1 device and a RAT 2 device. The wireless device 1106 and the wireless device 1108 may each have a RAT 2 device, but may not have a RAT 1 device. In other words, the wireless devices 1102 and 1104 may each be configured to transmit and receive transmissions using RAT 1 or RAT 2, while the wireless devices 1106 and 1108 may be configured to transmit and receive transmissions using RAT 2 but not using RAT 1. The wireless device 1102 may each be configured to transmit a transmission 1112 associated with RAT 1 to the wireless device 1104. The transmission 1112 may be transmitted using the RAT 1 device of the wireless device 1102 and may be received using the RAT 1 device of the wireless device 1104. A transmission 1114 may be transmitted to the wireless device 1106 as interference from the transmission 1112. It should be understood that transmission 1112 and transmission 1114 may be the same transmission received by different devices. The transmissions may be broadcast or groupcast to a plurality of wireless devices, or unicast to one wireless device and received by one or more other wireless devices as an interfering signal. The transmission 1114 may cause interference with a transmission received by the wireless device 1106, such as the transmission 1116. The transmission 1114 may be transmitted by the RAT 1 device of the wireless device 1102. The wireless device 1108 may be configured to transmit a transmission 1116 associated with RAT 2 to the wireless device 1106. The transmission 1116 may be transmitted using the RAT 2 device of the wireless device 1108 and may be received using the RAT 2 device of the wireless device 1106. A transmission 1118 may be transmitted to the wireless device 1102 as interference from the transmission 1116. The transmission 1118 may be transmitted by the RAT 2 device of the wireless device 1108. It should be understood that transmission 1118 and transmission 1116 may be the same transmission received by different devices. The transmissions may be broadcast or groupcast to a plurality of wireless devices, or unicast to one wireless device and received by one or more other wireless devices as an interfering signal.

The transmission 1114 associated with RAT 1 from the wireless device 1102 to the wireless device 1106 may interfere with receiving the transmission 1116 associated with RAT 2 from the wireless device 1108 to the wireless device 1106. In other words, the RAT 1 device of the wireless device 1102 may act as a strong blocker when it transmits the transmission 1114 associated with RAT 1 that may block the transmission 1116 associated with RAT 2 from being successfully received by the RAT 2 device of the wireless device 1106. The wireless device 1102 may be configured to protect one or more transmissions received from the wireless device 1108 by the wireless device 1106 associated with RAT 2. For example, the wireless device 1102 may be configured to protect transmissions having high priority packets or packets from nearby vehicles using the RAT 2 device, such as the wireless device 1106.

To that end, the wireless device 1102 may be configured to analyze RAT 2 transmissions that it receives from the wireless device 1106 and the wireless device 1108. For example, when the wireless device 1108 transmits a transmission 1116 to the wireless device 1106, a transmission 1118 may be sent to the wireless device 1102, which may be analyzed by the RAT 2 device of the wireless device 1102. It should be understood that transmission 1116 and transmission 1118 may be the same transmission received by different devices. The transmissions may be broadcast or groupcast to a plurality of wireless devices, or unicast to one wireless device and received by one or more other wireless devices as an interfering signal. Similarly, when the wireless device 1106 transmits a transmission 1120 to the wireless device 1108, a transmission 1115 may be sent to the wireless device 1102, which may be analyzed by the RAT 2 device of the wireless device 1102. It should be understood that transmission 1120 and transmission 1115 may be the same transmission received by different devices. The transmissions may be broadcast or groupcast to a plurality of wireless devices, or unicast to one wireless device and received by one or more other wireless devices as an interfering signal. Analyzing the transmission 1118 may allow the wireless device 1102 to determine attributes or properties of a transmission 1116 that will be sent from the wireless device 1108 to the wireless device 1106 in the future. Analyzing the transmission 1115 may allow the wireless device 1102 to determine a location of the wireless device 1106 or a relative distance between the wireless device 1102 and the wireless device 1106.

In some aspects, the RAT 2 device of the wireless device 1102 may be configured to communicate with the RAT 2 device of the wireless device 1106. In such aspects, the RAT 2 device of the wireless device 1102 may be configured to transmit a transmission 1113 to be received by the RAT 2 device of the wireless device 1106, and the RAT 2 device of the wireless device 1106 may be configured to transmit a transmission 1115 to be received by the RAT 2 device of the wireless device 1102. Thus, the transmission 1115 may be considered a direct transmission from the RAT 2 device of the wireless device 1106 having a target destination of the RAT 2 device of the wireless device 1102, or may be considered a transmission from the wireless device 1106 as a result of transmitting the transmission 1120 from the RAT 2 device of the wireless device 1106 to the RAT 2 device of the wireless device 1108.

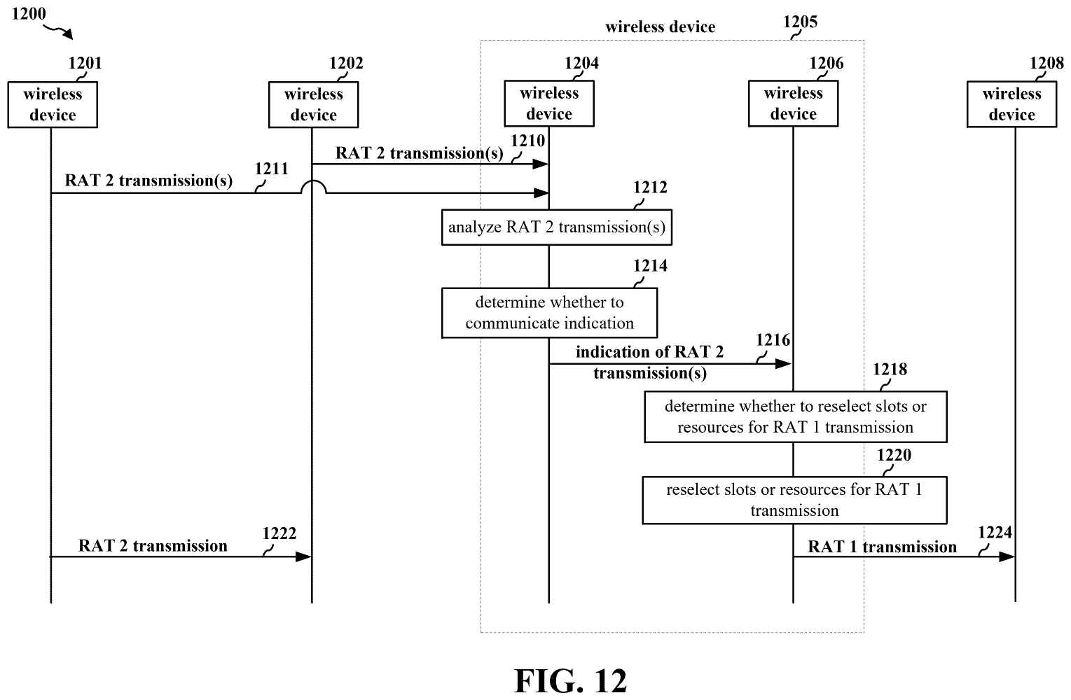

FIG. 12 illustrates a connection flow diagram 1200 for a plurality of wireless devices 1201, 1202, 1204, 1206, and 1208. The wireless devices 1204 and 1206 may be components of a wireless device 1205. In one aspect, the wireless device 1202 may be the wireless device 1106 in FIG. 11, the wireless device 1208 may be the wireless device 1104 in FIG. 11, the wireless device 1205 may be the wireless device 1102 in FIG. 11, the wireless device 1204 may be the RAT 2 device of the wireless device 1102 in FIG. 11, the wireless device 1206 may be the RAT 1 device of the wireless device 1102 in FIG. 11, and the wireless device 1201 may be the wireless device 1108 in FIG. 11. In other words, the wireless device 1202 and the wireless device 1204 may be configured to transmit RAT 2 transmissions with one another, the wireless device 1201 and the wireless device 1202 may be configured to transmit RAT 2 transmissions with one another, the wireless device 1206 and the wireless device 1208 may be configured to transmit RAT 1 transmissions with one another, and the wireless device 1204 and the wireless device 1206 may be configured to communicate with one another using a wired connection, such as a backhaul connection or a bus. The RAT 1 device may be, for example, an NR V2X transceiver and the RAT 2 device may be, for example, an LTE V2X transceiver.

The wireless device 1202 may be configured to transmit a set of RAT 2 transmissions 1210 to the wireless device 1204. The set of RAT 2 transmissions 1210 may be a transmission similar to the transmission 1115 in FIG. 11 received by the wireless device 1102 when the wireless device 1106 transmits (e.g., broadcasts, groupcasts, unicasts) the transmission 1120 to the wireless device 1108. In other words, the set of RAT 2 transmissions 1210 may be received by a plurality of wireless devices. The wireless device 1201 may be configured to transmit a set of RAT 2 transmissions 1211 to the wireless device 1204. The set of RAT 2 transmissions 1211 may be a transmission, such as the transmission 1118 in FIG. 11, received by the wireless device 1102 when the wireless device 1108 transmits (e.g., broadcast, groupcasts, unicasts) the transmission 1116 to the wireless device 1106.

At 1212, the wireless device 1204 may be configured to analyze the RAT 2 transmissions 1210 and 1211. For example, the wireless device 1204 may be configured to decode a control (e.g., SCI) of the set of RAT 2 transmissions 1210. The decoded control may have, for example, a priority indication of the set of RAT 2 transmissions 1210, or a periodicity of the set of RAT 2 transmissions 1210 (e.g., an RSVP). In some aspects, the wireless device 1204 may measure an RSRP of the set of RAT 2 transmissions 1210. The wireless device 1204 may be configured to decode data of the set of RAT 2 transmissions 1210. The decoded data may include, for example, a message having a position indication associated with the wireless device 1202, for example GNSS coordinates or a zone indicator. Such a message may be, for example, a BSM or a CAM message. The BSM or CAM message may have position data associated with the wireless device 1202, for example GNSS coordinates. The wireless device 1204 may use the position data to estimate a distance between the wireless device 1204 and the wireless device 1202, or the wireless device 1205 and the wireless device 1202. The wireless device 1204 may additionally or alternatively use RSRP data to estimate a distance between the wireless device 1204 and the wireless device 1202, or the wireless device 1205 and the wireless device 1202.

The wireless device 1204 may be configured to decode a control (e.g., SCI) of the set of RAT 2 transmissions 1210. The decoded control may have, for example, a priority indication of the set of RAT 2 transmissions 1211, or a periodicity of the set of RAT 2 transmissions 1211 (e.g., an RSVP) In some aspects, the wireless device 1204 may measure an RSRP of the set of RAT 2 transmissions 1211. The wireless device 1204 may be configured to decode data of the set of RAT 2 transmissions 1211. The decoded data may include, for example, a message having a position indication associated with the wireless device 1201, for example GNSS coordinates or a zone indicator. Such a message may be, for example, a BSM or a CAM message. The BSM or CAM message may have position data associated with the wireless device 1201, for example GNSS coordinates. The wireless device 1204 may use the position data to estimate a distance between the wireless device 1204 and the wireless device 1201, or the wireless device 1205 and the wireless device 1201. The wireless device 1204 may additionally or alternatively use RSRP data to estimate a distance between the wireless device 1204 and the wireless device 1201, or the wireless device 1205 and the wireless device 1201.

At 1214, the wireless device 1204 may be configured to determine whether to communicate an indication to protect an incoming transmission, such as the RAT 2 transmission 1222, to the wireless device 1202. The wireless device 1204 may be configured to communicate the indication to the wireless device 1206 based on an environmental variable trigger. In one aspect, the wireless device 1204 may be configured to communicate an indication to the wireless device 1206 if an RSRP of the set of RAT 2 transmissions 1210 is equal to or larger than an RSRP threshold value. In another aspect, the wireless device 1204 may be configured to communicate an indication to the wireless device 1206 if an estimated distance between the wireless device 1204 and the wireless device 1202, or the wireless device 1205 and the wireless device 1202, is equal or smaller than a distance threshold value. The wireless device 1204 may select the RSRP threshold value or the distance threshold value based on a priority indication of the set of RAT 2 transmissions 1210. Such values may be selected from a table saved to a memory accessible by the wireless device 1204. For example, the wireless device 1204 may select a higher RSRP threshold value or a lower distance threshold value for a higher priority indication and may select a lower RSRP threshold value or a higher distance threshold value for a lower priority indication. In some aspects, the wireless device 1204 may select the RSRP threshold value or the distance threshold value based on a congestion indicator, such as a CBR or a number of packets received within a time period. For example, the wireless device 1204 may select a higher RSRP threshold value or a lower distance threshold value for a higher CBR or number of packets received within a time period and may select a lower RSRP threshold value or a higher distance threshold value for a lower CBR or number of packets received within a time period.

A plurality of tables may be used to provide RSRP threshold values or distance threshold values. In one aspect, the wireless device 1204 may be configured to select a first table if an RSRP of the set of RAT 2 transmissions 1210 is equal to or larger than a second RSRP threshold value. In another aspect, the wireless device 1204 may be configured to select a first table if an estimated distance between the wireless device 1204 and the wireless device 1202, or the wireless device 1205 and the wireless device 1202, is equal or smaller than a distance threshold value. The first table may have RSRP threshold values that are higher than a second table, and may have distance values that are lower than the second table. In other words, if the wireless device 1204 determines that the wireless device 1202 is close to the wireless device 1204 or the wireless device 1205 (e.g., within 10 meters), then the wireless device 1204 may act to protect the RAT 2 transmission 1222 more aggressively by using a table with more conservative threshold values.

The wireless device 1204 may transmit the indication 1216 of the set of RAT 2 transmissions to the wireless device 1206. The indication 1216 may include the slots of the RAT 2 transmission 1222, or of a periodic interval for a set of RAT 2 transmissions, and the RAT 2 transmission 1222 may be a part of the set of periodic RAT 2 transmissions. In another aspect, the indication 1216 of the set of RAT 2 transmissions may include one or more attributes of the RAT 2 transmission 1222. For example, the indication 1216 may include at least one of an RSVP of the RAT 2 transmission 1222, a retransmission interval of the RAT 2 transmission 1222 (e.g., TDRI), a periodicity of the RAT 2 transmission 1222 (e.g., an RSVP), a candidate resource set of the RAT 2 transmission 1222, a set of slots associated with the RAT 2 transmission 1022, or a resource associated with the RAT 2 transmission 1222. In some aspects, one or more attributes of the RAT 2 transmission 1222 may be shared by the set of RAT 2 transmissions 1211. Thus, the indication 1216 of the set of RAT 2 transmissions may include one or more attributes of the set of RAT 2 transmissions 1211 that are shared with the RAT 2 transmission 1222.

In some aspects, the wireless device 1204 may assume a periodicity or an RSVP of the wireless device 1201 to transmit transmissions, such as the set of RAT 2 transmissions 1210, to be fixed (e.g., every 100 ms). In some aspects, the periodicity (e.g., an RSVP) of the set of RAT 2 transmissions 1210 may be changed, for example when congestion is detected by the wireless device 1201. At 1214, the wireless device 1204 may obtain an indication of congestion, and, in response, may alter one or more attributes of the indication 1216 of the set of RAT 2 transmissions transmitted to the wireless device 1206. In some aspects, the wireless device 1204 may obtain the indication of congestion from a wireless device, such as an RSU or a network entity. For example, the wireless device 1204 may measure a CBR as an indication of congestion level. In other aspects, the wireless device 1204 may obtain the indication of congestion by counting a number of packets received within a time period. When counting a number of packets received within a time period, the wireless device 1204 may remove duplicates, for example in response to a plurality of packets being received from of the same transmitter. If the wireless device 1204 receives a number of packets within a time period that meets or exceeds a threshold value, the wireless device 1204 may determine that a congestion event has occurred. As the wireless devices 1204 and 1201 may be in the same vicinity, the congestion level of RAT2 network can be the same for both devices. In response to obtaining an indication of congestion, the wireless device 1204 may estimate a new periodicity of the wireless device 1201, for example by analyzing a plurality of RAT 2 transmissions received from the wireless device 1201. If the wireless device 1204 is unable to estimate the new periodicity, the wireless device 1204 may refrain from transmitting the indication 1216 of the set of RAT 2 transmissions to the wireless device 1206.

The wireless device 1206 may have selected resources for the RAT 1 transmission to be transmitted to the wireless device 1208 during some future slots. At 1218, the wireless device 1206 may determine whether to reselect resources for a RAT 1 transmission to protect the RAT 2 transmission 1222. The RAT 1 transmission may have a set of slots that overlap with a set of slots of the RAT 2 transmission 1222. The RAT 1 transmission may use a frequency band or channel that overlaps with a set of candidate resources of the RAT 2 transmission 1222, or is adjacent to the set of candidate resources of the RAT 2 transmission 1222. Reselecting resources for the RAT 1 transmission may include, for example, reselecting resources for the RAT 1 transmission to be transmitted during a time period that does not overlap with the RAT 2 transmission 1222, by reselecting resources for the RAT 1 transmission to be transmitted using a frequency band or channel that does not interfere with the candidate resource set of the RAT 2 transmission 1222 (e.g., is not adjacent to the candidate resource set of the RAT 2 transmission 1222) during the same time period that does overlap with the RAT 2 transmission 1222, by reselecting resources for the RAT 1 transmission to be transmitted during a time period that does not overlap with the RAT 2 transmission 1222 and by reselecting resources using a frequency band or channel that does not interfere with the candidate resource set of the RAT 2 transmission 1222, or by refraining from transmitting the RAT 1 transmission.

The wireless device 1206 may be configured to reselect resources for the RAT 1 transmission 1224 before or after an indication to transmit the RAT 1 transmission 1224 has been transmitted. In one aspect, the wireless device 1206 may transmit an SCI scheduling the RAT 1 transmission 1224 prior to transmitting the RAT 1 transmission 1224. If the wireless device 1206 reselects resources for the RAT 1 transmission 1224 before transmitting the SCI, the wireless device 1206 may update the SCI with the reselected resources for scheduling the RAT 1 transmission 1224. If the wireless device 1206 reselects resources for the RAT 1 transmission 1224 after transmitting the SCI, the wireless device 1206 may transmit the RAT 1 transmission 1224 with the reselected resources, violating its own schedule, but the wireless device 1208 may still receive the RAT 1 transmission 1224 successfully as it may be configured to monitor transmissions during the same slots associated with pre-selected resources.

At 1220, the wireless device 1206 may reselect resources for the RAT 1 transmission. In one aspect, the wireless device 1206 may perform an SPS resource reselection to select resources for the RAT 1 transmission 1224 that do not overlap with reported slots of the RAT 2 transmission 1222. In another aspect, the wireless device 1206 may perform a resource pre-emption to select resources for the RAT 1 transmission 1224 that do not overlap with reported resources of the RAT 2 transmission 1222. The selected resources may include a frequency band or channel that is not adjacent to the candidate resource set of the RAT 2 transmission 1222. The wireless device 1206 may reselect slots or resources for the RAT 1 transmission by dropping the transmission such that the RAT 1 transmission 1224 is not transmitted. The wireless device 1206 may reselect resources for the RAT 1 transmission by dropping the transmission if the transmission is a PSFCH transmission. The wireless device 1206 may determine whether to drop a transmission based on at least one of a feedback mode of the RAT 1 transmission, a cast type (e.g., unicast, broadcast, multi-cast) of the RAT 1 transmission, a priority of the RAT 1 transmission, or a feedback distance of the RAT 1 transmission.

The wireless device 1206 may be configured to determine whether to reselect resources for the RAT 1 transmission based on a packet priority of the RAT 1 transmission, a remaining packet delay budget (PDB) of the RAT 1 transmission, or a number of retransmissions left for the RAT 1 transmission. In one aspect, if the packet priority of the RAT 1 transmission is equal to or above a threshold value, the wireless device 1206 may not reselect resources for the RAT 1 transmission. In another aspect, if the remaining PDB of the RAT 1 transmission or a number of retransmissions left for the RAT 1 transmission is equal to or below a threshold value, the wireless device 1206 may not reselect resources for the RAT 1 transmission.

The wireless device 1202 may transmit the RAT 2 transmission 1222 to the wireless device 1204. The wireless device 1206 may transmit the RAT 1 transmission 1224 to the wireless device 1208. As a result of the reselection of resources of the RAT 1 transmission at 1220, the RAT 1 transmission 1224 may not interfere with a successful receipt of the RAT 2 transmission 1222.

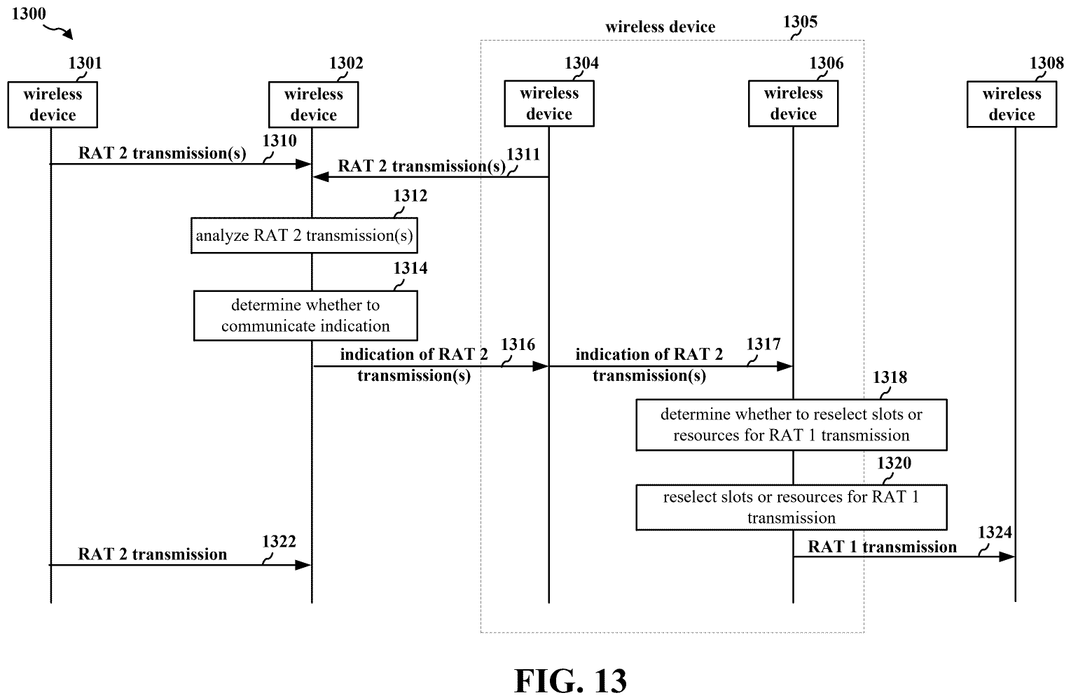

FIG. 13 illustrates a connection flow diagram 1300 for a plurality of wireless devices 1301, 1302, 1304, 1305, 1306, and 1308. The wireless devices 1301, 1302, 1304, 1305, 1306, and 1308 may be similar to the wireless devices 1201, 1202, 1204, 1205, 1206, and 1208 in FIG. 12. The wireless device 1302 and the wireless device 1304 may be configured to transmit RAT 2 transmissions with one another, the wireless device 1301 and the wireless device 1302 may be configured to transmit RAT 2 transmissions with one another, the wireless device 1306 and the wireless device 1308 may be configured to transmit RAT 1 transmissions with one another, and the wireless device 1304 and the wireless device 1306 may be configured to communicate with one another using a wired connection, such as a backhaul connection or a bus. The RAT 1 device may be, for example, an NR V2X transceiver and the RAT 2 device may be, for example, an LTE V2X transceiver.

The wireless device 1301 may be configured to transmit a set of RAT 2 transmissions 1310 to the wireless device 1302. The set of RAT 2 transmissions 1310 may be similar to the transmission 1116 in FIG. 11. The wireless device 1304 may be configured to transmit a set of RAT 2 transmissions 1311 to the wireless device 1302. The set of RAT 2 transmissions 1311 may be similar to the transmission 1113 in FIG. 11.

At 1312, the wireless device 1302 may be configured to analyze the RAT 2 transmissions 1310 and 1311. For example, the wireless device 1302 may be configured to decode a control (e.g., SCI) of the set of RAT 2 transmissions 1311. The decoded control may have, for example, a priority indication of the set of RAT 2 transmissions 1311, or a periodicity of the set of RAT 2 transmissions 1311 (e.g., an RSVP). In some aspects, the wireless device 1302 may measure an RSRP of the set of RAT 2 transmissions 1311. The wireless device 1302 may be configured to decode data of the set of RAT 2 transmissions 1311. The decoded data may include, for example, a message having a position indication associated with the wireless device 1304, for example GNSS coordinates or a zone indicator. Such a message may be, for example, a BSM or a CAM message. The BSM or CAM message may have position data associated with the wireless device 1304, for example GNSS coordinates. The wireless device 1302 may use the position data to estimate a distance between the wireless device 1302 and the wireless device 1304, or the wireless device 1305 and the wireless device 1302. The wireless device 1302 may additionally or alternatively use RSRP data to estimate a distance between the wireless device 1302 and the wireless device 1304 or the wireless device 1305.

The wireless device 1302 may be configured to decode a control (e.g., SCI) of the set of RAT 2 transmissions 1310. The decoded control may have, for example, a priority indication of the set of RAT 2 transmissions 1310, or a periodicity of the set of RAT 2 transmissions 1310 (e.g., an RSVP). In some aspects, the wireless device 1302 may measure an RSRP of the set of RAT 2 transmissions 1310. The wireless device 1302 may be configured to decode data of the set of RAT 2 transmissions 1310. The decoded data may include, for example, a message having a position indication associated with the wireless device 1301, for example GNSS coordinates or a zone indicator. Such a message may be, for example, a BSM or a CAM message. The BSM or CAM message may have position data associated with the wireless device 1301, for example GNSS coordinates. The wireless device 1302 may use the position data to estimate a distance between the wireless device 1302 and the wireless device 1301. The wireless device 1302 may additionally or alternatively use RSRP data to estimate a distance between the wireless device 1302 and the wireless device 1301.

At 1314, the wireless device 1302 may be configured to determine whether to communicate an indication to protect an incoming transmission, such as the RAT 2 transmission 1322, to the wireless device 1304. The wireless device 1302 may be configured to communicate the indication to the wireless device 1304 based on an environmental variable trigger. In one aspect, the wireless device 1302 may be configured to communicate an indication to the wireless device 1304 if an RSRP of the set of RAT 2 transmissions 1311 is equal to or larger than an RSRP threshold value. In another aspect, the wireless device 1302 may be configured to communicate an indication to the wireless device 1304 if an estimated distance between the wireless device 1302 and the wireless device 1304, or the estimated distance between the wireless device 1302 and the wireless device 1305, is equal or smaller than a distance threshold value. The wireless device 1302 may select the RSRP threshold value or the distance threshold value based on a priority indication of the set of RAT 2 transmissions 1310. Such values may be selected from a table saved to a memory accessible by the wireless device 1302. For example, the wireless device 1302 may select a higher RSRP threshold value or a lower distance threshold value for a higher priority indication and may select a lower RSRP threshold value or a higher distance threshold value for a lower priority indication. In some aspects, the wireless device 1302 may select the RSRP threshold value or the distance threshold value based on a congestion indicator, such as a CBR or a number of packets received within a time period. For example, the wireless device 1302 may select a higher RSRP threshold value or a lower distance threshold value for a higher CBR or number of packets received within a time period and may select a lower RSRP threshold value or a higher distance threshold value for a lower CBR or number of packets received within a time period.

A plurality of tables may be used to provide RSRP threshold values or distance threshold values. In one aspect, the wireless device 1302 may be configured to select a first table if an RSRP of the set of RAT 2 transmissions 1311 is equal to or larger than a second RSRP threshold value. In another aspect, the wireless device 1302 may be configured to select a first table if an estimated distance between the wireless device 1304 and the wireless device 1302, or the wireless device 1305 and the wireless device 1302, is equal or smaller than a distance threshold value. The first table may have RSRP threshold values that are higher than a second table, and may have distance values that are lower than the second table. In other words, if the wireless device 1302 determines that the wireless device 1304 or 1305 is close to the wireless device 1302 (e.g., within 10 meters), then the wireless device 1302 may act to protect the RAT 2 transmission 1322 more aggressively by using a table with more conservative threshold values.

The wireless device 1304 may transmit the indication 1316 of the set of RAT 2 transmissions to the wireless device 1304. The indication 1316 may be forwarded, in whole or in part, to the wireless device 1306 by the wireless device 1304 as the indication 1317. The indication 1317 may be communicated using a wired connection. The indication 1316 of the set of RAT 2 transmissions may include one or more attributes of the RAT 2 transmission 1322. The indication 1316 may include the slots of the RAT 2 transmission 1322, or of a periodic interval for a set of RAT 2 transmissions, and the RAT 2 transmission 1322 may be a part of the set of periodic RAT 2 transmissions. In another aspect, the indication 1316 may include at least one of an RSVP of the RAT 2 transmission 1322, a retransmission interval of the RAT 2 transmission 1322 (e.g., TDRI), a periodicity of the RAT 2 transmission 1322 (e.g., an RSVP), a candidate resource set of the RAT 2 transmission 1322, a set of slots associated with the RAT 2 transmission 1322, or a resource associated with the RAT 2 transmission 1322. In some aspects, one or more attributes of the RAT 2 transmission 1322 may be shared by the RAT 1 transmission 1310. Thus, the indication 1316 of the set of RAT 2 transmissions may include one or more attributes of the RAT 1 transmission 1310 that are shared with the RAT 2 transmission 1322.

In some aspects, the wireless device 1304 may assume a periodicity or an RSVP of the wireless device 1302 to transmit transmissions, such as the set of RAT 2 transmissions 1310, to be fixed (e.g., every 100 ms). In some aspects, the periodicity (e.g., an RSVP) of the set of RAT 2 transmissions 1310 may be changed, for example when congestion is detected by the wireless device 1302. At 1314, the wireless device 1304 may obtain an indication of congestion, and, in response, may alter one or more attributes of the indication 1316 of the set of RAT 2 transmissions transmitted to the wireless device 1306. In some aspects, the wireless device 1304 may obtain the indication of congestion from a wireless device, such as an RSU or a network entity. For example, the wireless device 1304 may receive a congestion indication from an RSU or a network entity, or may measure the CBR as an indication of a congestion level. In other aspects, the wireless device 1304 may obtain the indication of congestion by counting a number of packets received within a time period. When counting a number of packets received within a time period, the wireless device 1304 may remove duplicates, for example if a same packet is received from a plurality of transmitters. If the wireless device 1304 receives a number of packets within a time period that meets or exceeds a threshold value, the wireless device 1304 may determine that a congestion event has occurred. In response to obtaining an indication of congestion, the wireless device 1304 may estimate a new periodicity of the wireless device 1302, for example by analyzing a plurality of RAT 2 transmissions received from the wireless device 1302. If the wireless device 1304 is unable to estimate the new periodicity, the wireless device 1304 may refrain from transmitting the indication 1316 of the set of RAT 2 transmissions to the wireless device 1306.

The wireless device 1306 may have selected resources for the RAT 1 transmission to be transmitted to the wireless device 1308 during some future slots. At 1318, the wireless device 1306 may determine whether to reselect slots or resources for a RAT 1 transmission to protect the RAT 2 transmission 1322. The RAT 1 transmission may have a set of slots that overlap with a set of slots of the RAT 2 transmission 1322. The RAT 1 transmission may use a frequency band or channel that overlaps with a set of candidate resources of the RAT 2 transmission 1322, or is adjacent to the set of candidate resources of the RAT 2 transmission 1322. Reselecting resources for the RAT 1 transmission may include, for example, reselecting resources for the RAT 1 transmission to be transmitted during a time period that does not overlap with the RAT 2 transmission 1322, by reselecting resources for the RAT 1 transmission to be transmitted using a frequency band or channel that does not interfere with the candidate resource set of the RAT 2 transmission 1322 (e.g., is not adjacent to the candidate resource set of the RAT 2 transmission 1322) during the same time period that does overlap with the RAT 2 transmission 1322, by reselecting slots for the RAT 1 transmission to be transmitted during a time period that does not overlap with the RAT 2 transmission 1322 or by reselecting resources using a frequency band or channel that does not interfere with the candidate resource set of the RAT 2 transmission 1322, or by refraining from transmitting the RAT 1 transmission.

The wireless device 1306 may be configured to reselect resources for the RAT 1 transmission 1324 before or after an indication to transmit the RAT 1 transmission 1324 has been transmitted. In one aspect, the wireless device 1306 may transmit an SCI scheduling the RAT 1 transmission 1324 prior to transmitting the RAT 1 transmission 1324. If the wireless device 1306 reselects resources for the RAT 1 transmission 1324 before transmitting the SCI, the wireless device 1306 may update the SCI with the reselected resources for scheduling the RAT 1 transmission 1324. If the wireless device 1306 reselects slots or resources for the RAT 1 transmission 1324 after transmitting the SCI, the wireless device 1306 may transmit the RAT 1 transmission 1324 with the reselected resources, violating its own schedule, but the wireless device 1308 may still receive the RAT 1 transmission 1324 successfully as it may be configured to monitor transmissions during the same slots associate with pre-selected resources.

At 1320, the wireless device 1306 may reselect resources for the RAT 1 transmission. In one aspect, the wireless device 1306 may perform an SPS resource reselection to select resources for the RAT 1 transmission 1324 that do not overlap with reported slots of the RAT 2 transmission 1322. In another aspect, the wireless device 1306 may perform a resource pre-emption to select resources for the RAT 1 transmission 1324 that do not overlap with reported slots of the RAT 2 transmission 1322. The selected resources may include a frequency band or channel that is not adjacent to the candidate resource set of the RAT 2 transmission 1322. The wireless device 1306 may reselect resources for the RAT 1 transmission by dropping the data transmission such that the RAT 1 transmission 1324 is not transmitted. The wireless device 1306 may reselect resources for the RAT 1 transmission by dropping the transmission if the transmission is a PSFCH transmission. The wireless device 1306 may determine whether to drop a data transmission based on at least one of a feedback mode of the RAT 1 transmission, a cast type (e.g., unicast, broadcast, multi-cast) of the RAT 1 transmission, a priority of the RAT 1 transmission, or a feedback distance of the RAT 1 transmission.

The wireless device 1306 may be configured to determine whether to reselect resources for the RAT 1 transmission based on a packet priority of the RAT 1 transmission, a remaining packet delay budget (PDB) of the RAT 1 transmission, or a number of retransmissions left for the RAT 1 transmission. In one aspect, if the packet priority of the RAT 1 transmission is equal to or above a threshold value, the wireless device 1306 may not reselect resources for the RAT 1 transmission. In another aspect, if the remaining PDB of the RAT 1 transmission or a number of retransmissions left for the RAT 1 transmission is equal to or below a threshold value, the wireless device 1306 may not reselect resources for the RAT 1 transmission.

The wireless device 1302 may transmit the RAT 2 transmission 1322 to the wireless device 1304. The wireless device 1306 may transmit the RAT 1 transmission 1324 to the wireless device 1308. As a result of the reselection of resources for of the RAT 1 transmission at 1320, the RAT 1 transmission 1324 may not interfere with a successful receipt of the RAT 2 transmission 1322.

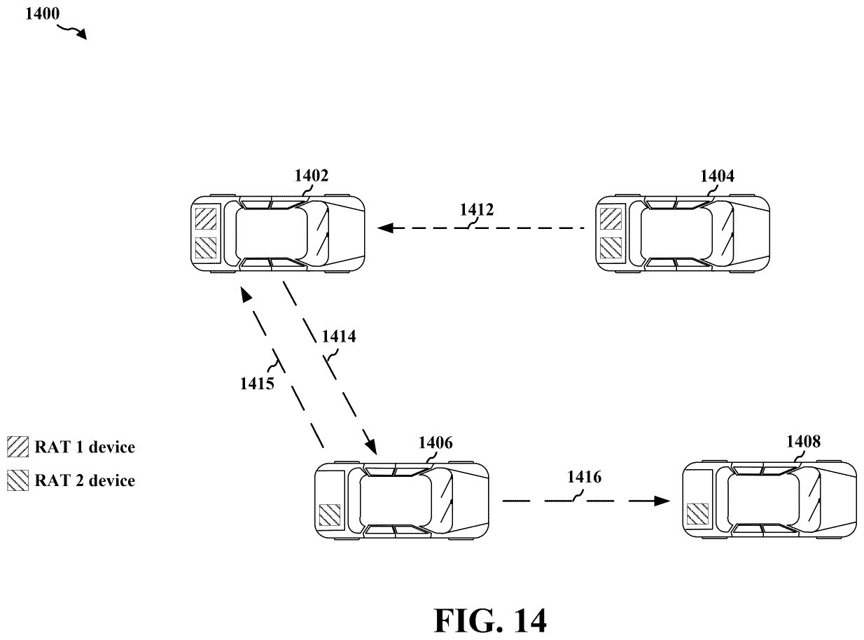

FIG. 14 illustrates an example 1400 of V2X communication between a wireless device 1402, a wireless device 1404, a wireless device 1406, and a wireless device 1408. The wireless device 1402, wireless device 1404, wireless device 1406, and wireless device 1408 may be similar to the wireless device 1102, the wireless device 1104, the wireless device 1106, and the wireless device 1106 in FIG. 11, respectively. The wireless device 1402 and the wireless device 1404 may each have both a RAT 1 device and a RAT 2 device. The wireless device 1406 and the wireless device 1408 may each have a RAT 2 device, but may not have a RAT 1 device. In other words, the wireless devices 1402 and 1404 may each be configured to transmit and receive transmissions using RAT 1 or RAT 2, while the wireless devices 1406 and 1408 may be configured to transmit and receive transmissions using RAT 2 but not using RAT 1. The wireless device 1404 may each be configured to transmit a transmission 1412 associated with RAT 1 to the wireless device 1402. The transmission 1412 may be transmitted using the RAT 1 device of the wireless device 1404 and may be received using the RAT I device of the wireless device 1402. The wireless device 1406 may be configured to transmit a transmission 1416 associated with RAT 2 to the wireless device 1408. The transmission 1416 may be transmitted using the RAT 2 device of the wireless device 1406 and may be received using the RAT 2 device of the wireless device 1408. A transmission 1415 may be transmitted to the wireless device 1402 as interference from the transmission 1416. The transmission 1415 may cause out of band interference with the transmission 1412. The transmission 1415 may be transmitted by the RAT 2 device of the wireless device 1406. It should be understood that transmission 1415 and transmission 1416 may be the same transmission received by different devices. The transmissions may be broadcast or groupcast to a plurality of wireless devices, or unicast to one wireless device and received by one or more other wireless devices as an interfering signal.

The transmission 1415 (associated with RAT 2) from the wireless device 1406 to the wireless device 1402 may interfere with the wireless device 1402 receiving the transmission 1412 associated with RAT 1 from the wireless device 1404 to the wireless device 1402. In other words, the RAT 2 device of the wireless device 1406 may act as a strong blocker when it transmits the transmission 1415 associated with RAT 2 that may block the transmission 1412 associated with RAT 1 from being successfully received by the RAT 1 device of the wireless device 1402. The wireless device 1406 may be configured to protect one or more transmissions received from the wireless device 1404 by the wireless device 1402 associated with RAT 1. For example, the wireless device 1406 may be configured to protect transmissions having high priority packets or packets from nearby vehicles using the RAT 2 device, such as the wireless device 1402.

The wireless device 1402 may be configured to analyze RAT 2 transmissions that it receives from the wireless device 1406. For example, when the wireless device 1406 transmits a transmission 1416 to the wireless device 1408, a transmission 1415 may be sent to the wireless device 1402, which may be analyzed by the RAT 2 device of the wireless device 1402. Analyzing the transmission 1415 may allow the wireless device 1402 to determine attributes or properties of a transmission 1416 that will be sent from the wireless device 1406 to the wireless device 1408 in the future. Analyzing the transmission 1415 may allow the wireless device 1402 to determine a location of the wireless device 1406 or a relative distance between the wireless device 1402 and the wireless device 1406.

In some aspects, the RAT 2 device of the wireless device 1402 may be configured to communicate with the RAT 2 device of the wireless device 1406. In such aspects, the RAT 2 device of the wireless device 1402 may be configured to transmit a transmission 1414 to be received by the RAT 2 device of the wireless device 1406. The wireless device 1406 may then use data from the transmission 1414 to protect incoming transmissions from the wireless device 1404 to the wireless device 1402, such as the transmission 1412, by scheduling around the transmission 1412.

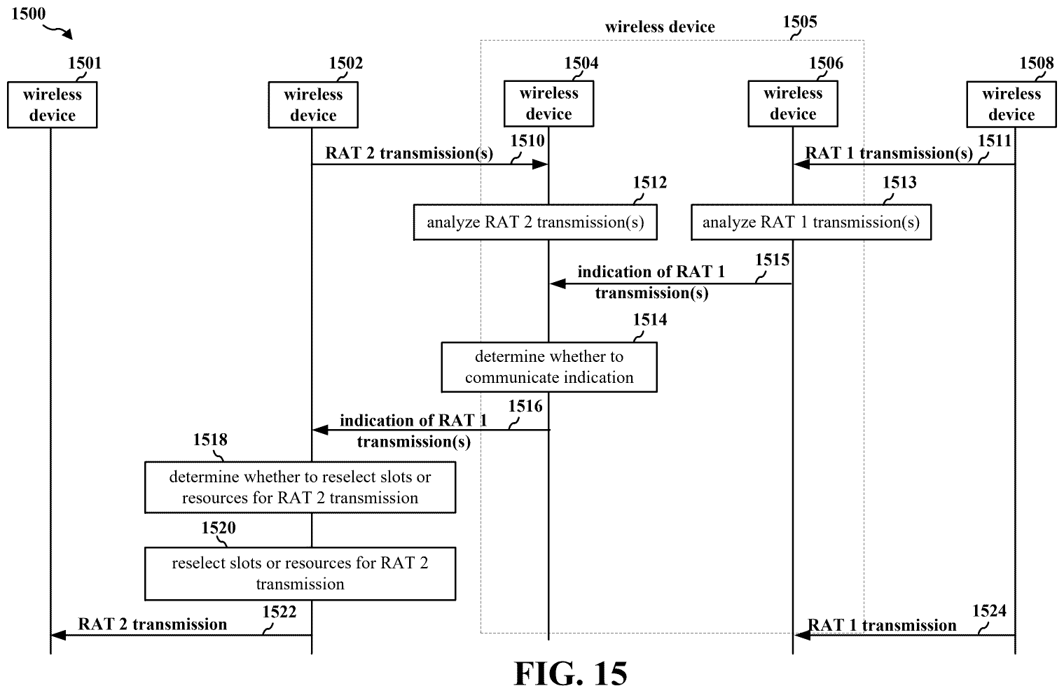

FIG. 15 illustrates a connection flow diagram 1500 for a plurality of wireless devices 1501, 1502, 1504, 1506, and 1508. The wireless devices 1504 and 1506 may be components of a wireless device 1505. In one aspect, the wireless device 1502 may be the wireless device 1406 in FIG. 14, the wireless device 1508 may be the wireless device 1404 in FIG. 14, the wireless device 1505 may be the wireless device 1402 in FIG. 14, the wireless device 1504 may be the RAT 2 device of the wireless device 1402 in FIG. 14, the wireless device 1506 may be the RAT 1 device of the wireless device 1402 in FIG. 14, and the wireless device 1501 may be the wireless device 1408 in FIG. 14. In other words, the wireless device 1502 and the wireless device 1504 may be configured to transmit RAT 2 transmissions with one another, the wireless device 1501 and the wireless device 1502 may be configured to transmit RAT 2 transmissions with one another, the wireless device 1506 and the wireless device 1508 may be configured to transmit RAT 1 transmissions with one another, and the wireless device 1504 and the wireless device 1506 may be configured to communicate with one another using a wired connection, such as a backhaul connection or a bus. The RAT 1 device may be, for example, an NR V2X transceiver and the RAT 2 device may be, for example, an LTE V2X transceiver.

The wireless device 1502 may be configured to transmit a set of RAT 2 transmissions 1510 to the wireless device 1504. The set of RAT 2 transmissions 1510 may be a transmission similar to the transmission 1415 in FIG. 14 received by the wireless device 1402 when the wireless device 1406 transmits (e.g., broadcasts, groupcasts, unicasts) the transmission 1416 to the wireless device 1408. In other words, the set of RAT 2 transmissions 1510 may be received by a plurality of wireless devices.

At 1512, the wireless device 1504 may be configured to decode a control (e.g., SCI) of the set of RAT 2 transmissions 1510. The decoded control may have, for example, a priority indication of the set of RAT 2 transmissions 1510, a periodicity of the set of RAT 2 transmissions 1510 (e.g., an RSVP). In some aspects, the wireless device 1504 may measure an RSRP of the set of RAT 2 transmissions 1510. The wireless device 1504 may be configured to decode data of the set of RAT 2 transmissions 1510. The decoded data may include, for example, a message having a position indication associated with the wireless device 1502, for example GNSS coordinates or a zone indicator. Such a message may be, for example, a BSM or a CAM message. The BSM or CAM message may have position data associated with the wireless device 1502, for example GNSS coordinates. The wireless device 1504 may use the position data to estimate a distance between the wireless device 1504 and the wireless device 1502, or the wireless device 1505 and the wireless device 1502. The wireless device 1504 may additionally or alternatively use RSRP data to estimate a distance between the wireless device 1504 and the wireless device 1502, or the wireless device 1505 and the wireless device 1502.

The wireless device 1508 may be configured to transmit a set of RAT 1 transmissions 1511 to the wireless device 1506. At 1513, the wireless device 1506 may be configured to decode a control (e.g., SCI) of the set of RAT 1 transmissions 1511. The decoded control may have, for example, a priority indication of the set of RAT 1 transmissions 1511, a periodicity of the of the set of RAT 1 transmissions 1511 (e.g., an RSVP), one or more properties of a future retransmission of a packet of the set of RAT 1 transmissions 1511, zone information of the wireless device 1508, a packet priority of the set of RAT I transmissions 1511, a cast type of the set of RAT 1 transmissions 1511, or a feedback distance of the set of RAT 1 transmissions 1511 (e.g., a maximum communication range). In some aspects, the wireless device 1506 may measure an RSRP of the set of RAT 1 transmissions 1511. The wireless device 1506 may be configured to decode data of the set of RAT 1 transmissions 1511. The decoded data may include, for example, a message having a position indication associated with the wireless device 1508, for example GNSS coordinates or a zone indicator. Such a message may be, for example, a BSM or a CAM message. The BSM or CAM message may have position data associated with the wireless device 1508, for example GNSS coordinates. The wireless device 1506 may use the position data to estimate a distance between the wireless device 1506 and the wireless device 1508, or the wireless device 1505 and the wireless device 1508. The wireless device 1506 may additionally or alternatively use RSRP data to estimate a distance between the wireless device 1506 and the wireless device 1508, or the wireless device 1505 and the wireless device 1508. The wireless device 1506 may transmit one or more properties of the set of RAT 1 transmissions 1511 to the wireless device 1504 as the indication 1515 of the set of RAT 1 transmissions. The indication 1515 of the set of RAT 1 transmissions may include at least a portion of the derived data above.

At 1514, the wireless device 1504 may be configured to determine whether to communicate an indication to protect an incoming transmission, such as the RAT 1 transmission 1524, to the wireless device 1506. The wireless device 1504 may be configured to communicate the indication to the wireless device 1502 based on an environmental variable trigger. In one aspect, the wireless device 1504 may be configured to communicate an indication to the wireless device 1502 if an RSRP of the set of RAT 1 transmissions 1511 is equal to or larger than an RSRP threshold value. In another aspect, the wireless device 1504 may be configured to communicate an indication to the wireless device 1502 if an estimated distance between the wireless device 1504 and the wireless device 1502, or the wireless device 1505 and the wireless device 1502, is equal or smaller than a distance threshold value. The wireless device 1504 may select the RSRP threshold value or the distance threshold value based on a priority indication of the set of RAT 1 transmissions 1511, a packet priority of the set of RAT 1 transmissions 1511, a cast type of the set of RAT 1 transmissions 1511, or a feedback distance of the set of RAT 1 transmissions 1511 (e.g., a maximum communication range). Such values may be selected from a table saved to a memory accessible by the wireless device 1504. For example, the wireless device 1504 may select a higher RSRP threshold value or a lower distance threshold value for a first value and may select a lower RSRP threshold value or a higher distance threshold value for a second value. In some aspects, the wireless device 1504 may select the RSRP threshold value or the distance threshold value based on a congestion indicator, such as a CBR or a number of packets received within a time period. For example, the wireless device 1504 may select a higher RSRP threshold value or a lower distance threshold value for a higher CBR or number of packets received within a time period and may select a lower RSRP threshold value or a higher distance threshold value for a lower CBR or number of packets received within a time period.

The wireless device 1504 may transmit the indication 1516 of the set of RAT 1 transmissions to the wireless device 1502. The indication 1516 may include the slots of the RAT 1 transmission 1524, or of a periodic interval for a set of RAT 1 transmissions, and the RAT 1 transmission 1524 may be a part of the set of periodic RAT 1 transmissions. In another aspect, the indication 1516 of the set of RAT 1 transmissions may include one or more attributes of the RAT 1 transmission 1524. For example, the indication 1516 may include at least one of an RSVP of the RAT 1 transmission 1524, a retransmission interval of the RAT 1 transmission 1524 (e.g., TDRI), a periodicity of the RAT 1 transmission 1524 (e.g., an RSVP), a candidate resource set of RAT 1 transmission 1524, a set of slots associated with the RAT 1 transmission 1024, or a resource associated with the RAT 1 transmission 1524. In some aspects, one or more attributes of the RAT 1 transmission 1524 may be shared by the set of RAT 1 transmissions 1511. Thus, the indication 1516 of the set of RAT 1 transmissions may include one or more attributes of the set of RAT 1 transmissions 1511 that are shared with the RAT 1 transmission 1524.

In some aspects, the wireless device 1504 may assume a periodicity or an RSVP of the wireless device 1502 to transmit transmissions, such as the set of RAT 2 transmissions 1510, to be fixed (e.g., every 100 ms). In some aspects, the periodicity (e.g., an RSVP) of the set of RAT 2 transmissions 1510 may be changed, for example when congestion is detected by the wireless device 1502. At 1514, the wireless device 1504 may obtain an indication of congestion, and, in response, may alter one or more attributes of the indication 1516 of the RAT 2 transmission transmitted to the wireless device 1506. In some aspects, the wireless device 1504 may obtain the indication of congestion from a wireless device, such as an RSU or a network entity. For example, the wireless device 1504 may receive a CBR from an RSU or a network entity, or may measure a CBR as an indication of a congestion level. In other aspects, the wireless device 1504 may obtain the indication of congestion by counting a number of packets received within a time period. When counting a number of packets received within a time period, the wireless device 1504 may remove duplicates, for example if a same packet is received from a plurality of transmitters. If the wireless device 1504 receives a number of packets within a time period that meets or exceeds a threshold value, the wireless device 1504 may determine that a congestion event has occurred. In response to obtaining an indication of congestion, the wireless device 1504 may estimate a new periodicity of the wireless device 1502, for example by analyzing a plurality of RAT 2 transmissions received from the wireless device 1502. If the wireless device 1504 is unable to estimate the new periodicity, the wireless device 1504 may refrain from transmitting the indication 1516 of the RAT 2 transmission to the wireless device 1506.

The wireless device 1502 may have selected resources for the RAT 1 transmission to be transmitted to the wireless device 1501 during some future slots. At 1518, the wireless device 1502 may determine whether to reselect resources for a RAT 2 transmission to protect the RAT 1 transmission 1524. The RAT 2 transmission may have a set of slots that overlap with a set of slots of the RAT 1 transmission 1524. The RAT 2 transmission may use a frequency band or channel that overlaps with a set of candidate resources of the RAT 1 transmission 1524, or is adjacent to the set of candidate resources of the RAT 1 transmission 1524. Reselecting resources for the RAT 2 transmission may include, for example, reselecting resources for the RAT 2 transmission to be transmitted during a time period that does not overlap with the RAT 1 transmission 1524, by reselecting resources for the RAT 2 transmission to be transmitted using a frequency band or channel that does not interfere with the candidate resource set of the RAT 1 transmission 1524 (e.g., is not adjacent to the candidate resource set of the RAT 1 transmission 1524), or by refraining from transmitting the RAT 2 transmission.

The wireless device 1502 may be configured to reselect resources for the RAT 1 transmission 1522 before or after an indication to transmit the RAT 1 transmission 1522 has been transmitted. In one aspect, the wireless device 1502 may transmit an SCI scheduling the RAT 1 transmission 1522 prior to transmitting the RAT 1 transmission 1522. If the wireless device 1502 reselects resources for the RAT 1 transmission 1522 before transmitting the SCI, the wireless device 1502 may update the SCI with the reselected resources for scheduling the RAT 1 transmission 1522. If the wireless device 1502 reselects resources for the RAT 1 transmission 1522 after transmitting the SCI, the wireless device 1502 may transmit the RAT 1 transmission 1522 with the reselected resources, violating its own schedule, but the wireless device 1501 may still receive the RAT 1 transmission 1522 successfully as it may be configured to monitor transmissions during the same slots associated with pre-selected resources.

At 1520, the wireless device 1502 may reselect resources for the RAT 2 transmission 1522. In one aspect, the wireless device 1502 may perform an SPS resource reselection to select resources for the RAT 2 transmission 1522 that do not overlap with reported slots of the RAT 1 transmission 1524. In another aspect, the wireless device 1502 may perform a resource pre-emption to select resources for the RAT 2 transmission 1522 that do not overlap with reported slots associated with resources of the RAT 1 transmission 1524. The selected resources may include a frequency band or channel that is not adjacent to the candidate resource set of the RAT 1 transmission 1524. The wireless device 1502 may reselect resources for the RAT 2 transmission by dropping the data transmission (e.g., by selecting zero resources) such that the RAT 2 transmission 1522 is not transmitted.

The wireless device 1502 may be configured to determine whether to reselect resources for the RAT 2 transmission based on a packet priority of the RAT 2 transmission, a remaining packet delay budget (PDB) of the RAT 2 transmission, or a number of retransmissions left for the RAT 2 transmission. In one aspect, if the packet priority of the RAT 2 transmission is equal to or above a threshold value, the wireless device 1502 may not reselect slots or resources for the RAT 2 transmission. In another aspect, if the remaining PDB of the RAT 2 transmission is equal to or below a threshold value, the wireless device 1502 may not reselect resources for the RAT 2 transmission.

The wireless device 1502 may transmit the RAT 2 transmission 1522 to the wireless device 1501. The wireless device 1508 may transmit the RAT 1 transmission 1524 to the wireless device 1506. As a result of the reselection of resources for of the RAT 2 transmission at 1520, the RAT 2 transmission 1522 may not interfere with a successful receipt of the RAT 1 transmission 1524.

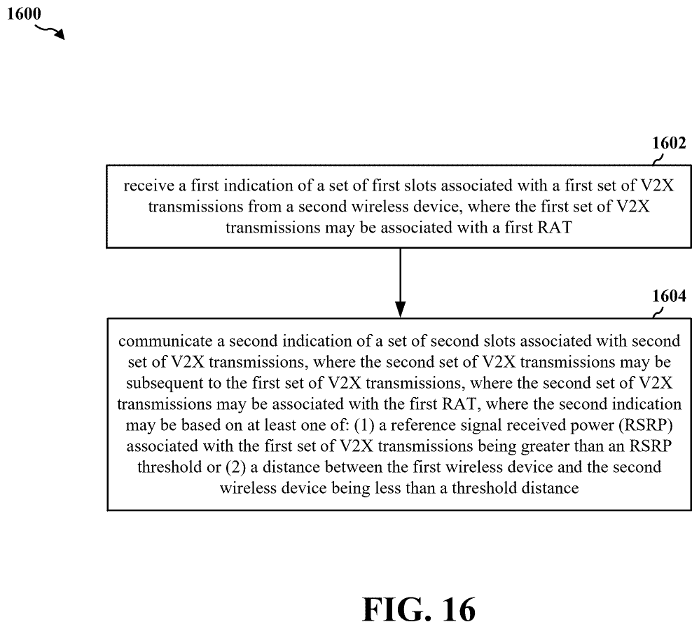

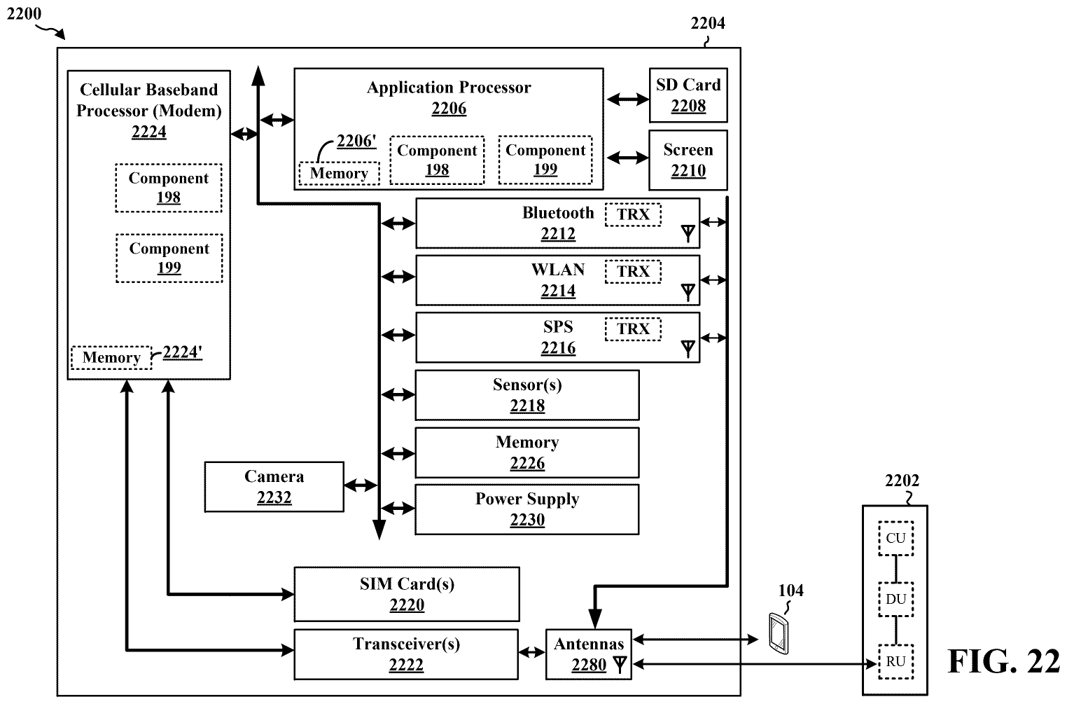

FIG. 16 is a flowchart 1600 of a method of wireless communication. The method may be performed by a first wireless device (e.g., UE 104, UE 402, UE 404, UE 406, UE 408; device 310, device 350; wireless device 702, wireless device 804, wireless device 805, wireless device 902, wireless device 1004, wireless device 1005, wireless device 1102, wireless device 1106, wireless device 1204, wireless device 1205, wireless device 1302, wireless device 1402, wireless device 1406, wireless device 1504, wireless device 1505, wireless device 1506; apparatus 2204). At 1602, the first wireless device may receive a first indication of a set of first slots associated with a first set of V2X transmissions from a second wireless device, where the first set of V2X transmissions may be associated with a first RAT. For example, 1602 may be performed by the wireless device 804 in FIG. 8, which may receive a set of RAT 2 transmissions 810 including a set of first data packets associated with a set of first slots. The set of RAT 2 transmissions 810 may be received from the wireless device 802. The set of RAT 2 transmissions 810 may be associated with RAT 2. 1602 may also be performed by the apparatus 2204 in FIG. 22.

At 1604, the first wireless device may communicate a second indication of a set of second slots associated with second set of V2X transmissions. The second set of V2X transmissions may be subsequent to the first set of V2X transmissions. The second set of V2X transmissions may be associated with the first RAT. The second indication may be based on at least one of: (1) a reference signal received power (RSRP) associated with the first set of V2X transmissions being greater than an RSRP threshold or (2) a distance between the first wireless device and the second wireless device being less than a threshold distance. For example, 1604 may be performed by the wireless device 804 in FIG. 8, which may communicate an indication 816 of a RAT 2 transmission to the wireless device 806. The indication may include a set of second slots associated with the RAT 2 transmission 822. The RAT 2 transmission 822 may be subsequent to the set of RAT 2 transmissions 810. The RAT 2 transmission may be associated with RAT 2. The indication may be based on at least one of (1) an RSRP associated with the set of RAT 2 transmissions 810 being greater than an RSRP threshold, or (2) a distance between the wireless device 804 and the wireless device 802 being less than a threshold distance. 1604 may also be performed by the apparatus 2204 in FIG. 22.

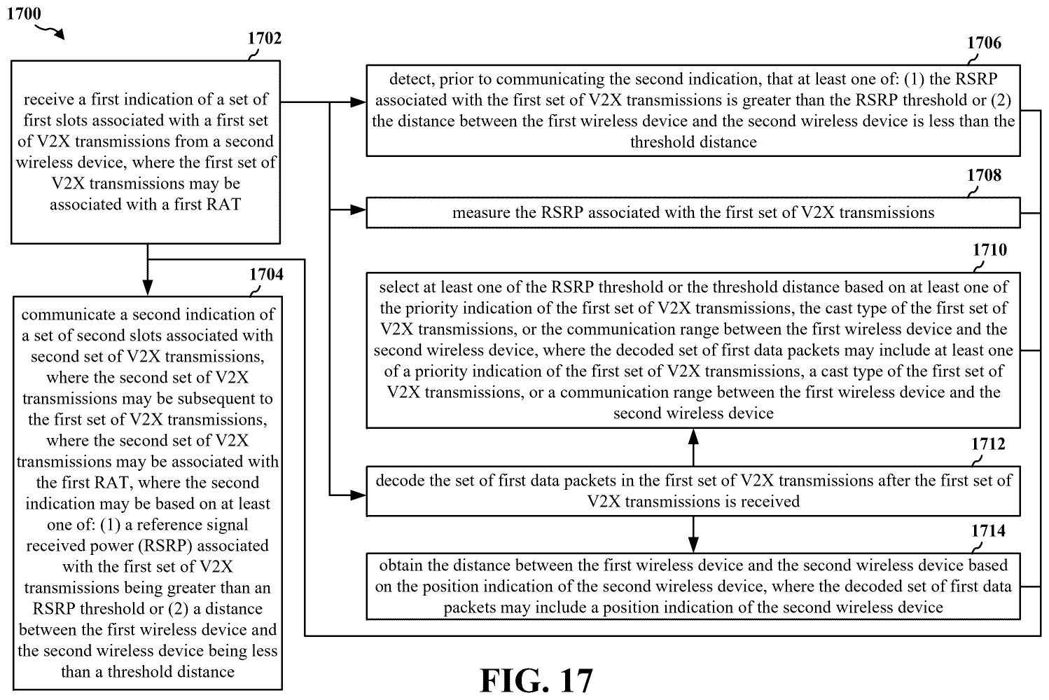

FIG. 17 is a flowchart 1700 of a method of wireless communication. The method may be performed by a first wireless device (e.g., UE 104, UE 402, UE 404, UE 406, UE 408; device 310, device 350; wireless device 702, wireless device 804, wireless device 805, wireless device 902, wireless device 1004, wireless device 1005, wireless device 1102, wireless device 1106, wireless device 1204, wireless device 1205, wireless device 1302, wireless device 1402, wireless device 1406, wireless device 1504, wireless device 1505, wireless device 1506; apparatus 2204). At 1702, the first wireless device may receive a first indication of a set of first slots associated with a first set of V2X transmissions from a second wireless device, where the first set of V2X transmissions may be associated with a first RAT. For example, 1702 may be performed by the wireless device 804 in FIG. 8, which may receive a set of RAT 2 transmissions 810 including a set of first data packets associated with a set of first slots. The set of RAT 2 transmissions 810 may be received from the wireless device 802. The set of RAT 2 transmissions 810 may be associated with RAT 2. 1702 may also be performed by the apparatus 2204 in FIG. 22.

At 1706, the first wireless device may detect, prior to communicating the second indication, that at least one of: (1) the RSRP associated with the first set of V2X transmissions is greater than the RSRP threshold or (2) the distance between the first wireless device and the second wireless device is less than the threshold distance. For example, 1706 may be performed by the wireless device 804 in FIG. 8, which may detect, prior to transmitting the indication 816 of the set of RAT 2 transmissions, that at least one of (1) the RSRP associated with the set of RAT 2 transmissions 810 is greater than the RSRP threshold, or (2) the distance between the wireless device 804 and the wireless device 802 is less than the threshold distance. 1706 may also be performed by the apparatus 2204 in FIG. 22.

At 1708, the first wireless device may measure the RSRP associated with the first set of V2X transmissions. For example, 1706 may be performed by the wireless device 804 in FIG. 8, which may measure the RSRP associated with the set of RAT 2 transmissions 810. 1706 may also be performed by the apparatus 2204 in FIG. 22.

At 1712, the first wireless device may decode the set of first data packets in the first set of V2X transmissions after the first set of V2X transmissions is received. For example, 1706 may be performed by the wireless device 804 in FIG. 8, which may decode the set of data packets in the set of RAT 2 transmissions 810 after the set of RAT 2 transmissions 810 is received by the wireless device 804. 1706 may also be performed by the apparatus 2204 in FIG. 22.

At 1710, the first wireless device may select at least one of the RSRP threshold or the threshold distance based on at least one of the priority indication of the first set of V2X transmissions, the cast type of the first set of V2X transmissions, or the communication range between the first wireless device and the second wireless device, where the decoded set of first data packets may include at least one of a priority indication of the first set of V2X transmissions, a cast type of the first set of V2X transmissions, or a communication range between the first wireless device and the second wireless device. For example, 1706 may be performed by the wireless device 804 in FIG. 8, which may select at least one of the RSRP threshold or the threshold distance based on at least one of the priority indication of the set of RAT 2 transmissions 810, the cast type of the set of RAT 2 transmissions 810, or the feedback distance between the wireless device 804 and the wireless device 802. The decoded set of first data packets from the RAT 2 transmission may include at least one of a priority indication of the first set of V2X transmissions, a cast type of the first set of V2X transmissions, or a feedback distance between the first wireless device and the second wireless device. 1706 may also be performed by the apparatus 2204 in FIG. 22.

At 1714, the first wireless device may obtain the distance between the first wireless device and the second wireless device based on the position indication of the second wireless device, where the decoded set of first data packets may include a position indication of the second wireless device. For example, 1706 may be performed by the wireless device 804 in FIG. 8, which may obtain the distance between the wireless device 804 and the wireless device 802 based on the position of the wireless device 802. The decoded set of data packets from the set of RAT 2 transmissions 810 may include a position of the wireless device 802. 1706 may also be performed by the apparatus 2204 in FIG. 22.

At 1704, the first wireless device may communicate a second indication of a set of second slots associated with second set of V2X transmissions. The second set of V2X transmissions may be subsequent to the first set of V2X transmissions. The second set of V2X transmissions may be associated with the first RAT. The second indication may be based on at least one of: (1) a reference signal received power (RSRP) associated with the first set of V2X transmissions being greater than an RSRP threshold or (2) a distance between the first wireless device and the second wireless device being less than a threshold distance. For example, 1704 may be performed by the wireless device 804 in FIG. 8, which may communicate an indication 816 of a RAT 2 transmission to the wireless device 806. The indication may include a set of second slots associated with the RAT 2 transmission 822. The RAT 2 transmission 822 may be subsequent to the set of RAT 2 transmissions 810. The RAT 2 transmission may be associated with RAT 2. The indication may be based on at least one of (1) an RSRP associated with the set of RAT 2 transmissions 810 being greater than an RSRP threshold, or (2) a distance between the wireless device 804 and the wireless device 802 being less than a threshold distance. 1704 may also be performed by the apparatus 2204 in FIG. 22.

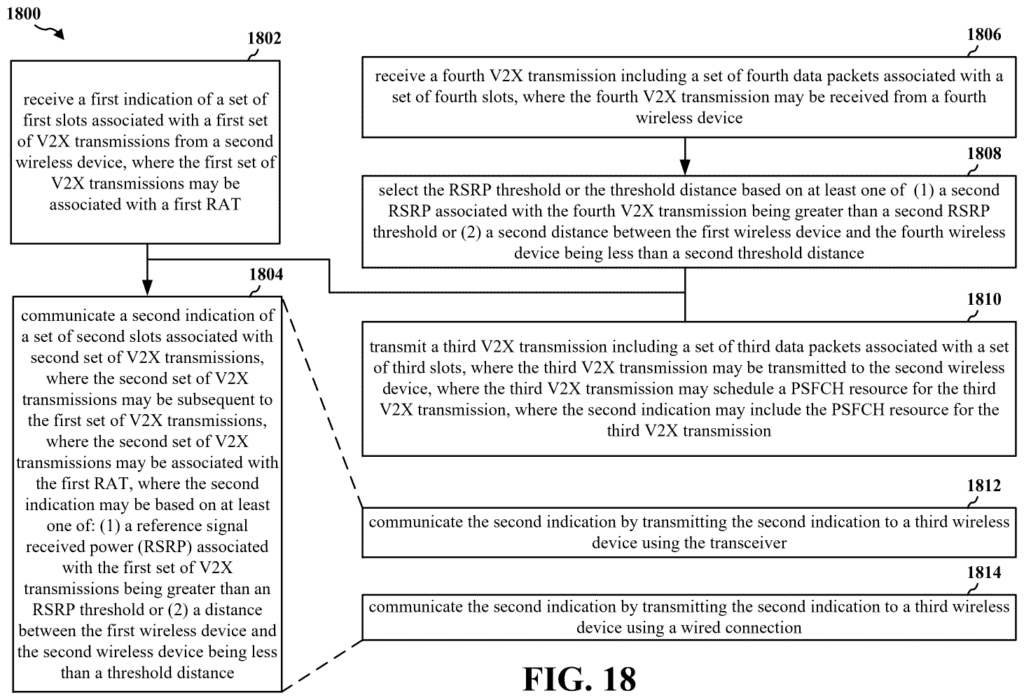

FIG. 18 is a flowchart 1800 of a method of wireless communication. The method may be performed by a first wireless device (e.g., UE 104, UE 402, UE 404, UE 406, UE 408; device 310, device 350; wireless device 702, wireless device 804, wireless device 805, wireless device 902, wireless device 1004, wireless device 1005, wireless device 1102, wireless device 1106, wireless device 1204, wireless device 1205, wireless device 1302, wireless device 1402, wireless device 1406, wireless device 1504, wireless device 1505, wireless device 1506; apparatus 2204). At 1802, the first wireless device may receive a first indication of a set of first slots associated with a first set of V2X transmissions from a second wireless device, where the first set of V2X transmissions may be associated with a first RAT. For example, 1802 may be performed by the wireless device 804 in FIG. 8, which may receive a set of RAT 2 transmissions 810 including a set of first data packets associated with a set of first slots. The set of RAT 2 transmissions 810 may be received from the wireless device 802. The set of RAT 2 transmissions 810 may be associated with RAT 2. 1802 may also be performed by the apparatus 2204 in FIG. 22.

At 1806, the first wireless device may receive a fourth V2X transmission including a set of fourth data packets associated with a set of fourth slots. The fourth V2X transmission may be received from a fourth wireless device. The fourth one or more V2X transmissions may be associated with the first RAT. For example, 1806 may be performed by the wireless device 1204 in FIG. 12, which may receive a set of RAT 2 transmissions 1210, including a set of data packets associated with a set of slots. The set of RAT 2 transmissions 1210 may be received from the wireless device 1202. The set of RAT 2 transmissions 1210 may be associated with RAT 2. 1806 may also be performed by the apparatus 2204 in FIG. 22.

At 1808, the first wireless device may select the RSRP threshold or the threshold distance based on at least one of (1) a second RSRP associated with the fourth V2X transmission being greater than a second RSRP threshold or (2) a second distance between the first wireless device and the fourth wireless device being less than a second threshold distance. For example, 1808 may be performed by the wireless device 1204 in FIG. 12, which may, at 1214, select an RSRP threshold or a threshold distance based on at least one of (a) an RSRP associated with the set of RAT 2 transmissions 1210 being greater than a second RSRP threshold, or (2) a distance between the wireless device 1204 and the wireless device 1202 being less than a second threshold distance. 1808 may also be performed by the apparatus 2204 in FIG. 22.

At 1810, the first wireless device may transmit a third V2X transmission including a set of third data packets associated with a set of third slots. The third V2X transmission may be transmitted to the second wireless device. The third V2X transmission may schedule a PSFCH resource for the third V2X transmission. The second indication may include the PSFCH resource for the third V2X transmission. For example, 1810 may be performed by the wireless device 1006 in FIG. 10, which may transmit a set of RAT 1 transmissions 1013 including a set of data packets associated with as set of slots. The set of RAT 1 transmissions 1013 may be transmitted to the wireless device 1006. The set of RAT 1 transmissions 1013 may be associated with RAT 1. The set of RAT 1 transmissions 1013 may schedule a PSFCH resource for the set of RAT 1 transmissions 1013. The indication 1016 of the set of RAT 1 transmissions may indicate the PSFCH resource for the set of RAT 1 transmissions 1013. 1810 may also be performed by the apparatus 2204 in FIG. 22.

At 1804, the first wireless device may communicate a second indication of a set of second slots associated with second set of V2X transmissions. The second set of V2X transmissions may be subsequent to the first set of V2X transmissions. The second set of V2X transmissions may be associated with the first RAT. The second indication may be based on at least one of: (1) a reference signal received power (RSRP) associated with the first set of V2X transmissions being greater than an RSRP threshold or (2) a distance between the first wireless device and the second wireless device being less than a threshold distance. For example, 1804 may be performed by the wireless device 804 in FIG. 8, which may communicate an indication 816 of a RAT 2 transmission to the wireless device 806. The indication may include a set of second slots associated with the RAT 2 transmission 822. The RAT 2 transmission 822 may be subsequent to the set of RAT 2 transmissions 810. The RAT 2 transmission may be associated with RAT 2. The indication may be based on at least one of (1) an RSRP associated with the set of RAT 2 transmissions 810 being greater than an RSRP threshold, or (2) a distance between the wireless device 804 and the wireless device 802 being less than a threshold distance. 1804 may also be performed by the apparatus 2204 in FIG. 22.

At 1812, the first wireless device may communicate the second indication by transmitting the second indication to a third wireless device using the transceiver. For example, 1812 may be performed by the wireless device 1504 in FIG. 15, which may communicate the indication 1516 of the set of RAT 1 transmissions by transmitting the indication 1516 to the wireless device 1502 using a wireless transceiver. 1812 may also be performed by the apparatus 2204 in FIG. 22.

At 1814, the first wireless device may communicate the second indication by transmitting the second indication to a third wireless device using a wired connection. For example, 1814 may be performed by the wireless device 804 in FIG. 8, which may transmit the indication 816 of the set of RAT 2 transmissions to the wireless device 806 using a wired connection. 1814 may also be performed by the apparatus 2204 in FIG. 22.

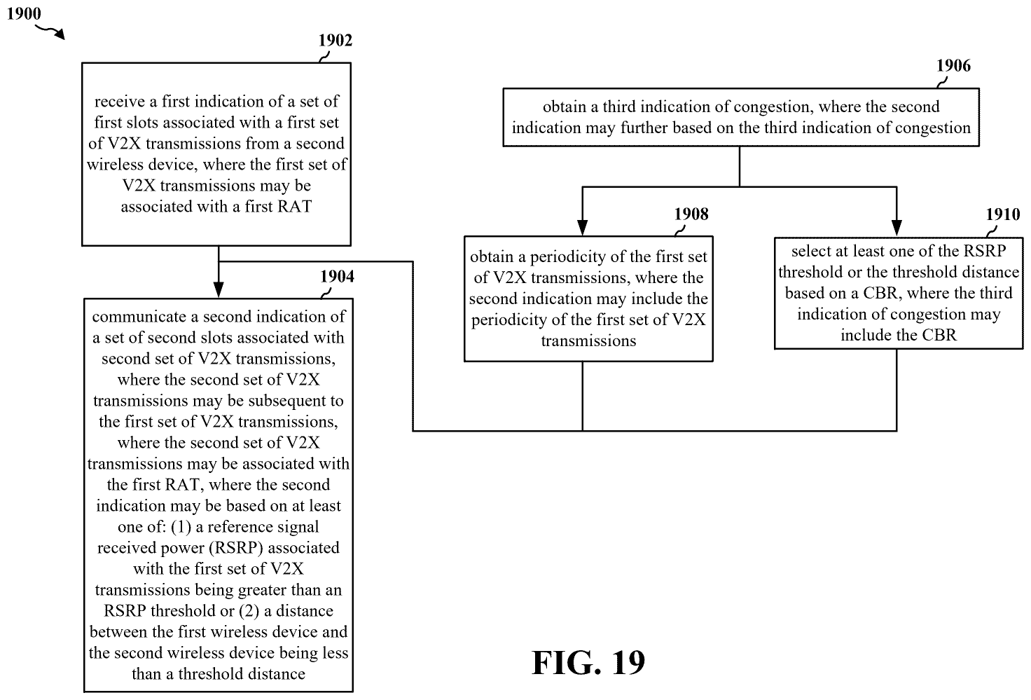

FIG. 19 is a flowchart 1900 of a method of wireless communication. The method may be performed by a first wireless device (e.g., UE 104, UE 402, UE 404, UE 406, UE 408; device 310, device 350; wireless device 702, wireless device 804, wireless device 805, wireless device 902, wireless device 1004, wireless device 1005, wireless device 1102, wireless device 1106, wireless device 1204, wireless device 1205, wireless device 1302, wireless device 1402, wireless device 1406, wireless device 1504, wireless device 1505, wireless device 1506; apparatus 2204). At 1902, the first wireless device may receive a first indication of a set of first slots associated with a first set of V2X transmissions from a second wireless device, where the first set of V2X transmissions may be associated with a first RAT. For example, 1902 may be performed by the wireless device 804 in FIG. 8, which may receive a set of RAT 2 transmissions 810 including a set of first data packets associated with a set of first slots. The set of RAT 2 transmissions 810 may be received from the wireless device 802. The set of RAT 2 transmissions 810 may be associated with RAT 2. 1902 may also be performed by the apparatus 2204 in FIG. 22.

At 1906, the first wireless device may obtain a third indication of congestion. The second indication may further based on the third indication of congestion. For example, 1906 may be performed by the wireless device 804 in FIG. 8, which may obtain an indication of congestion at 814 by counting a number of packets received within a time period. The indication 816 of the set of RAT 2 transmissions may be based on the indication of congestion for example by having a new periodicity (e.g., an RSVP) estimated by the wireless device 804. 1906 may also be performed by the apparatus 2204 in FIG. 22.

At 1908, the first wireless device may obtain a periodicity of the first set of V2X transmissions, where the second indication may include the periodicity of the first set of V2X transmissions. For example, 1908 may be performed by the wireless device 804 in FIG. 8, which may estimate a new periodicity that the wireless device 802 uses for its RAT 2 transmissions, such as the set of RAT 2 transmissions 810. The indication 816 of the set of RAT 2 transmissions may include the estimated periodicity of the set of RAT 2 transmissions 810. 1908 may also be performed by the apparatus 2204 in FIG. 22.

At 1910, the first wireless device may select at least one of the RSRP threshold or the threshold distance based on a CBR, where the third indication of congestion may include the CBR. In one aspect, 1910 may be performed by the wireless device 804 in FIG. 8, which may select at least one of the RSRP threshold or the threshold distance based on a CBR. The indication of congestion may include the CBR. 1910 may also be performed by the apparatus 2204 in FIG. 22.

At 1904, the first wireless device may communicate a second indication of a set of second slots associated with second set of V2X transmissions. The second set of V2X transmissions may be subsequent to the first set of V2X transmissions. The second set of V2X transmissions may be associated with the first RAT. The second indication may be based on at least one of: (1) a reference signal received power (RSRP) associated with the first set of V2X transmissions being greater than an RSRP threshold or (2) a distance between the first wireless device and the second wireless device being less than a threshold distance. For example, 1904 may be performed by the wireless device 804 in FIG. 8, which may communicate an indication 816 of a RAT 2 transmission to the wireless device 806. The indication may include a set of second slots associated with the RAT 2 transmission 822. The RAT 2 transmission 822 may be subsequent to the set of RAT 2 transmissions 810. The RAT 2 transmission may be associated with RAT 2. The indication may be based on at least one of (1) an RSRP associated with the set of RAT 2 transmissions 810 being greater than an RSRP threshold, or (2) a distance between the wireless device 804 and the wireless device 802 being less than a threshold distance. 1904 may also be performed by the apparatus 2204 in FIG. 22.

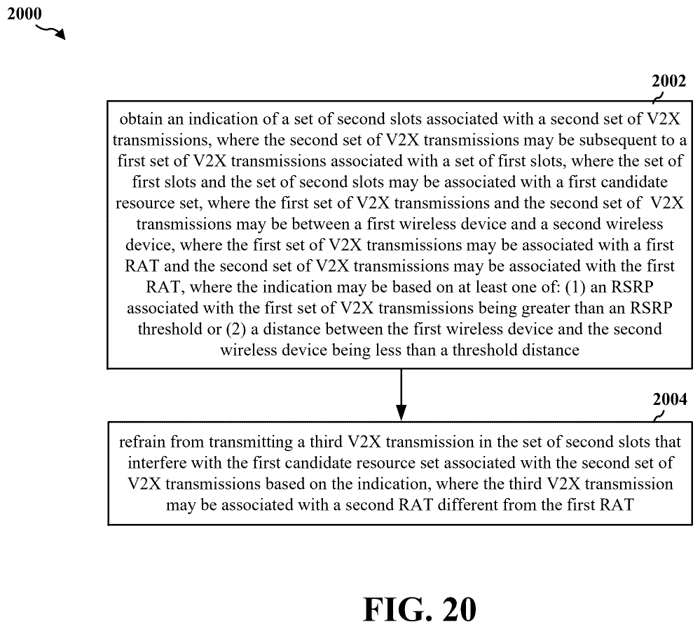

FIG. 20 is a flowchart 2000 of a method of wireless communication. The method may be performed by a third wireless device (e.g., UE 104, UE 402, UE 404, UE 406, UE 408; device 310, device 350; wireless device 702, wireless device 806, wireless device 805, wireless device 902, wireless device 1006, wireless device 1005, wireless device 1102, wireless device 1106, wireless device 1206, wireless device 1205, wireless device 1306, wireless device 1305, wireless device 1402, wireless device 1406, wireless device 1502; apparatus 2204). At 2002, the third wireless device may obtain an indication of a set of second slots associated with a second set of V2X transmissions. The second set of V2X transmissions may be subsequent to a first set of V2X transmissions associated with a set of first slots. The set of first slots and the set of second slots may be associated with a first candidate resource set. The first set of V2X transmissions and the second set of V2X transmissions may be between a first wireless device and a second wireless device. The first set of V2X transmissions may be associated with a first RAT and the second set of V2X transmissions may be associated with the first RAT. The indication may be based on at least one of: (1) an RSRP associated with the first set of V2X transmissions being greater than an RSRP threshold or (2) a distance between the first wireless device and the second wireless device being less than a threshold distance. For example, 2002 may be performed by the wireless device 806 in FIG. 8, which may obtain an indication 816 of a set of second slots associated with the RAT 2 transmission 822. The RAT 2 transmission 822 may be subsequent to the set of RAT 2 transmissions 810 associated with a first set of slots. The first set of slots and the second set of slots may be associated with a candidate resource set. The set of RAT 2 transmissions 810 and the RAT 2 transmission 822 may be between the wireless device 804 and the wireless device 802. The set of RAT 2 transmissions 810 may be associated with RAT 2 and the RAT 2 transmission 822 may be associated with RAT 2. The indication 816 of the set of RAT 2 transmissions may be based on at least one of (1) an RSRP associated with the set of RAT 2 transmissions 810 being greater than an RSRP threshold, or (2) a distance between the wireless device 804 and the wireless device 802 being less than a threshold distance. 2002 may also be performed by the apparatus 2204 in FIG. 22.

At 2004, the third wireless device may refrain from transmitting a third V2X transmission in the set of second slots that interfere with the first candidate resource set associated with the second set of V2X transmissions based on the indication. The third V2X transmission may be associated with a second RAT different from the first RAT. For example, 2004 may be performed by the wireless device 806 in FIG. 8, which may refrain from transmitting a one or more RAT 1 transmissions in a set of slots that interfere with the candidate resource set associated with the one or more RAT 2 transmissions 822 based on the indication 816 of the set of RAT 2 transmissions. The wireless device 806 may refrain from transmitting the one or more RAT 1 transmissions in the set of slots by reselecting resources for the RAT 1 transmission at 820. 2004 may also be performed by the apparatus 2204 in FIG. 22.

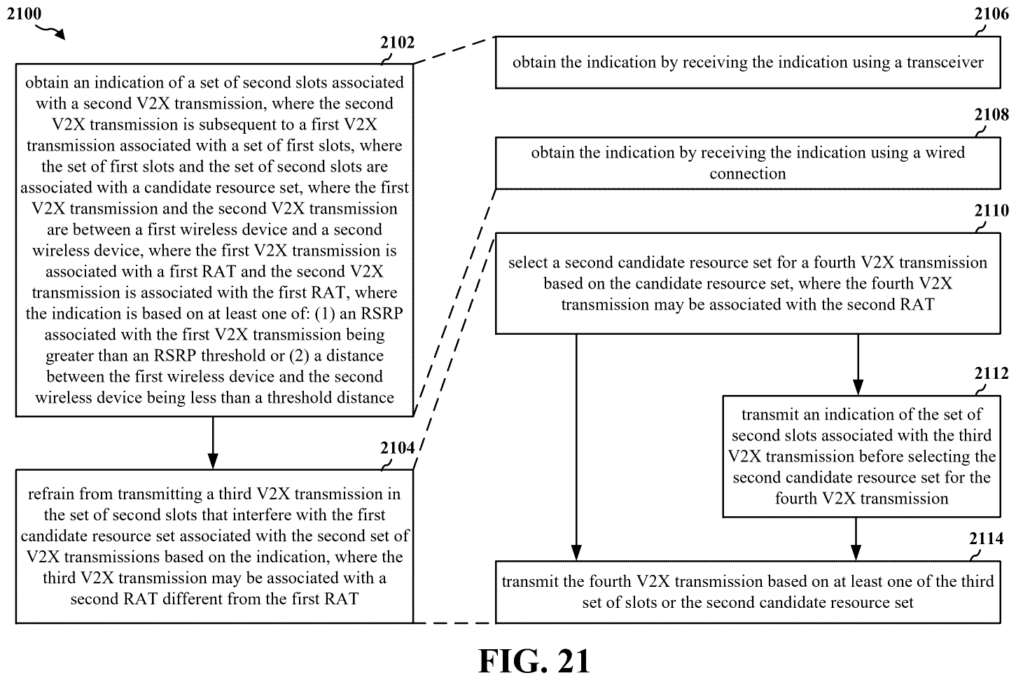

FIG. 21 is a flowchart 2100 of a method of wireless communication. The method may be performed by a third wireless device (e.g., UE 104, UE 402, UE 404, UE 406, UE 408; device 310, device 350; wireless device 702, wireless device 806, wireless device 805, wireless device 902, wireless device 1006, wireless device 1005, wireless device 1102, wireless device 1106, wireless device 1206, wireless device 1205, wireless device 1306, wireless device 1305, wireless device 1402, wireless device 1406, wireless device 1502; apparatus 2204). At 2102, the third wireless device may obtain an indication of a set of second slots associated with a second set of V2X transmissions. The second set of V2X transmissions may be subsequent to a first set of V2X transmissions associated with a set of first slots. The set of first slots and the set of second slots may be associated with a candidate resource set. The first set of V2X transmissions and the second set of V2X transmissions may be between a first wireless device and a second wireless device. The first set of V2X transmissions may be associated with a first RAT and the second V2X transmission is associated with the first RAT. The indication may be based on at least one of: (1) an RSRP associated with the first set of V2X transmissions being greater than an RSRP threshold or (2) a distance between the first wireless device and the second wireless device being less than a threshold distance. For example, 2102 may be performed by the wireless device 806 in FIG. 8, which may obtain an indication 816 of a set of second slots associated with the RAT 2 transmission 822. The one or more RAT 2 transmissions 822 may be subsequent to the set of RAT 2 transmissions 810 associated with a first set of slots. The first set of slots and the second set of slots may be associated with a candidate resource set. The set of RAT 2 transmissions 810 and the one or more RAT 2 transmissions 822 may be between the wireless device 804 and the wireless device 802. The set of RAT 2 transmissions 810 may be associated with RAT 2 and the one or more RAT 2 transmissions 822 may be associated with RAT 2. The indication 816 of the set of RAT 2 transmissions may be based on at least one of (1) an RSRP associated with the set of RAT 2 transmissions 810 being greater than an RSRP threshold, or (2) a distance between the wireless device 804 and the wireless device 802 being less than a threshold distance. 2102 may also be performed by the apparatus 2204 in FIG. 22.

At 2106, the first wireless device may obtain the indication by receiving the indication using a transceiver. For example, 2106 may be performed by the wireless device 1502 in FIG. 15, which may obtain the indication 1516 of the set of RAT 1 transmissions by receiving the indication 1516 using a wireless transceiver. 2106 may also be performed by the apparatus 2204 in FIG. 22.

At 2108, the first wireless device may obtain the indication by receiving the indication using a wired connection. For example, 2108 may be performed by the wireless device 806 in FIG. 8, which may obtain the indication 816 of the set of RAT 2 transmissions by receiving the indication using a wired connection. 2108 may also be performed by the apparatus 2204 in FIG. 22.

At 2104, the third wireless device may refrain from transmitting a third V2X transmission in the set of second slots that interfere with the first candidate resource set associated with the second set of V2X transmissions based on the indication. The third V2X transmission may be associated with a second RAT different from the first RAT. For example, 2104 may be performed by the wireless device 806 in FIG. 8, which may refrain from transmitting a one or more RAT 1 transmissions in a set of slots that interfere with the candidate resource set associated with the RAT 2 transmission 822 based on the indication 816 of the set of RAT 2 transmissions. The wireless device 806 may refrain from transmitting the one or more RAT 1 transmissions in the set of slots by reselecting resources for the RAT 1 transmissions at 820. 2104 may also be performed by the apparatus 2204 in FIG. 22.

At 2110, the first wireless device may select a second candidate resource set for a fourth V2X transmission based on the candidate resource set. The fourth V2X transmission may be associated with the second RAT. For example, 2110 may be performed by the wireless device 806 in FIG. 8, which, at 820, may reselect a set of resources for a RAT 1 transmission 824 based on the initial selected candidate resources interfering with the RAT 2 transmission 822. The RAT 1 transmission 824 is associated with RAT 1. 2110 may also be performed by the apparatus 2204 in FIG. 22.

At 2112, the first wireless device may transmit an indication of the set of second slots associated with the third V2X transmission before selecting the second candidate resource set for the fourth V2X transmission. For example, 2112 may be performed by the wireless device 804 in FIG. 8, which may transmit an indication of the set of second slots associated with the RAT 1 transmission 824 before selecting the second candidate resource set for the RAT 1 transmission 824 at 820. 2112 may also be performed by the apparatus 2204 in FIG. 22.

At 2114, the first wireless device may transmit the fourth V2X transmission based on at least one of the third set of the second candidate resource set. For example, 2114 may be performed by the wireless device 804 in FIG. 8, which may transmit the RAT 1 transmission based on at least one of the set of the resources reselected at 820. 2114 may also be performed by the apparatus 2204 in FIG. 22.

FIG. 22 is a diagram 2200 illustrating an example of a hardware implementation for an apparatus 2204. The apparatus 2204 may be a UE, a component of a UE, or may implement UE functionality. In some aspects, the apparatus 2204 may include a cellular baseband processor 2224 (also referred to as a modem) coupled to one or more transceivers 2222 (e.g., cellular RF transceiver). The cellular baseband processor 2224 may include on-chip memory 2224′. In some aspects, the apparatus 2204 may further include one or more subscriber identity modules (SIM) cards 2220 and an application processor 2206 coupled to a secure digital (SD) card 2208 and a screen 2210. The application processor 2206 may include on-chip memory 2206′. In some aspects, the apparatus 2204 may further include a Bluetooth module 2212, a WLAN module 2214, an SPS module 2216 (e.g., GNSS module), one or more sensor modules 2218 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory 2226, a power supply 2230, and/or a camera 2232. The Bluetooth module 2212, the WLAN module 2214, and the SPS module 2216 may include an on-chip transceiver (or in some cases, just a receiver (Rx)). The Bluetooth module 2212, the WLAN module 2214, and the SPS module 2216 may include their own dedicated antennas and/or utilize the antennas 2280 for communication. The cellular baseband processor 2224 communicates through the transceiver(s) 2222 via one or more antennas 2280 with the UE 104 and/or with an RU associated with a network entity 2202. The cellular baseband processor 2224 and the application processor 2206 may each include a computer-readable medium/memory 2224′, 2206′, respectively. The additional memory 2226 may also be considered a computer-readable medium/memory. Each computer-readable medium/memory 2224′, 2206′, 2226 may be non-transitory. The cellular baseband processor 2224 and the application processor 2206 are each responsible for general processing, including the execution of software stored on the computer-readable medium/memory. The software, when executed by the cellular baseband processor 2224/application processor 2206, causes the cellular baseband processor 2224/application processor 2206 to perform the various functions described supra. The computer-readable medium/memory may also be used for storing data that is manipulated by the cellular baseband processor 2224/application processor 2206 when executing software. The cellular baseband processor 2224/application processor 2206 may be a component of the device 350 and may include the memory 360 and/or at least one of the Tx processor 368, the Rx processor 356, and the controller/processor 359. In one configuration, the apparatus 2204 may be a processor chip (modem and/or application) and include just the cellular baseband processor 2224 and/or the application processor 2206, and in another configuration, the apparatus 2204 may be the entire UE (e.g., see device 350 of FIG. 3) and include the additional modules of the apparatus 2204.

As discussed supra, the component 198 may be configured to receive a first set of V2X transmissions having a set of first data packets associated with a set of first slots. The first set of V2X transmissions may be received from a second wireless device and may be associated with a first RAT. The component 198 may be configured to communicate an indication of a set of second slots associated with a second set of V2X transmissions. The second set of V2X transmissions may be subsequent to the first set of V2X transmissions. The second set of V2X transmissions may be associated with the first RAT. The indication may be based on at least one of: (1) an RSRP associated with the first set of V2X transmissions being greater than an RSRP threshold or (2) a distance between the apparatus 2204 and the second wireless device being less than a threshold distance. The component 198 may be within the cellular baseband processor 2224, the application processor 2206, or both the cellular baseband processor 2224 and the application processor 2206. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 2204 may include a variety of components configured for various functions. In one configuration, the apparatus 2204, and in particular the cellular baseband processor 2224 and/or the application processor 2206, includes means for receiving a first set of V2X transmissions including a set of first data packets associated with a set of first slots. The apparatus 2204 may include means for communicating an indication of a set of second slots associated with a second set of V2X transmissions. The apparatus 2204 may include means for decoding the set of first data packets in the first set of V2X transmissions after the first set of V2X transmissions is receive. The apparatus 2204 may include means for selecting at least one of the RSRP threshold or the threshold distance based on at least one of the PPPP of the first set of V2X transmissions, the cast type of the first set of V2X transmissions, or the feedback distance between the first wireless device and the second wireless device. The apparatus 2204 may include means for obtaining the distance between the first wireless device and the second wireless device based on the position of the second wireless device. The apparatus 2204 may include means for detecting, prior to communicating the indication, that at least one of: (1) the RSRP associated with the first set of V2X transmissions is greater than the RSRP threshold or (2) the distance between the first wireless device and the second wireless device is less than the threshold distance. The apparatus 2204 may include means for measuring the RSRP associated with the first set of V2X transmissions. The apparatus 2204 may include means for transmitting a one or more third V2X transmissions including a set of third data packets associated with a set of third slots. The apparatus 2204 may include means for communicating the indication by transmitting the indication to a third wireless device using a wireless transceiver. The apparatus 2204 may include means for communicating the indication by transmitting the indication to a third wireless device using a wired connection. The apparatus 2204 may include means for receiving a one or more fourth V2X transmissions including a set of fourth data packets associated with a set of fourth slots. The apparatus 2204 may include means for selecting the RSRP threshold or the threshold distance based on at least one of (1) a second RSRP associated with the one or more fourth V2X transmissions being greater than a second RSRP threshold or (2) a second distance between the first wireless device and the fourth wireless device being less than a second threshold distance. The apparatus 2204 may include means for obtaining a second indication of congestion. The apparatus 2204 may include means for obtaining a periodicity of the first set of V2X transmissions. The apparatus 2204 may include means for selecting at least one of the RSRP threshold or the threshold distance based on the CBR. The means may be the component 198 of the apparatus 2204 configured to perform the functions recited by the means. As described supra, the apparatus 2204 may include the Tx processor 368, the Rx processor 356, and the controller/processor 359. As such, in one configuration, the means may be the Tx processor 368, the Rx processor 356, and/or the controller/processor 359 configured to perform the functions recited by the means.

As discussed supra, the component 199 may be configured to obtain an indication of a set of second slots associated with a second set of V2X transmissions. The second set of V2X transmissions may be subsequent to a first set of V2X transmissions associated with a set of first slots. The set of first slots and the set of second slots may be associated with a candidate resource set. The first set of V2X transmissions and the second set of V2X transmissions may be between a first wireless device and a second wireless device. The first set of V2X transmissions may be associated with a first RAT. The second set of V2X transmissions may be associated with the first RAT. The indication may be based on at least one of: (1) an RSRP associated with the first set of V2X transmissions being greater than an RSRP threshold or (2) a distance between the first wireless device and the second wireless device being less than a threshold distance. The component 199 may be configured to refrain from transmitting a one or more third V2X transmissions in the set of second slots that overlap with the candidate resource set associated with the second set of V2X transmissions based on the indication. The third V2X transmission may be associated with a second RAT different from the first RAT. The component 199 may be within the cellular baseband processor 2224, the application processor 2206, or both the cellular baseband processor 2224 and the application processor 2206. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 2204 may include a variety of components configured for various functions. In one configuration, the apparatus 2204, and in particular the cellular baseband processor 2224 and/or the application processor 2206, includes means for obtaining an indication of a set of second slots associated with a second set of V2X transmissions. The apparatus 2204 may include means for refraining from transmitting a one or more third V2X transmissions in the set of second slots that overlap with the candidate resource set associated with the second set of V2X transmissions based on the indication. The apparatus 2204 may include means for selecting a set of resources for a one or more fourth V2X transmissions based on the set of second slots and the candidate resource set. The apparatus 2204 may include means for refraining from transmitting the one or more third V2X transmissions also based on at least one of a priority of the third V2X transmission, a remaining PDB of the one or more third V2X transmission, or a number of retransmissions of the one or more third V2X transmission. The apparatus 2204 may include means for refraining from transmitting the one or more third V2X transmission also based on at least one of a feedback mode of the transmission, a cast type of the transmission, a priority of the transmission, or a feedback distance of the transmission. The apparatus 2204 may include means for obtaining the indication by receiving the indication using a wireless transceiver. The apparatus 2204 may include means for obtaining the indication by receiving the indication using a wired connection. The means may be the component 199 of the apparatus 2204 configured to perform the functions recited by the means. As described supra, the apparatus 2204 may include the Tx processor 368, the Rx processor 356, and the controller/processor 359. As such, in one configuration, the means may be the Tx processor 368, the Rx processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. A “set” or a “subset” of elements should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data.

The following aspects are illustrative only and may be combined with other aspects or teachings described herein, without limitation.

Aspect 1 is a method of wireless communication at a first wireless device, where the method may include receiving a first set of V2X transmissions including a set of first data packets associated with a set of first slots. The first set of V2X transmissions may be received from a second wireless device. The first set of V2X transmissions may be associated with a first RAT. The method may further include communicating an indication of a set of second slots associated with a second V2X transmission. The second V2X transmission may be subsequent to the first set of V2X transmissions. The second V2X transmission may be associated with the first RAT. The indication may be based on at least one of: (1) a RSRP associated with the first set of V2X transmissions being greater than an RSRP threshold or (2) a distance between the first wireless device and the second wireless device being less than a threshold distance.

Aspect 2 is the method of aspect 1, where the method may further include decoding the set of first data packets in the first set of V2X transmissions after the first set of V2X transmissions is received.

Aspect 3 is the method of aspect 2, where the decoded set of first data packets may include at least one of a PPPP of the first set of V2X transmissions, a cast type of the first set of V2X transmissions, or a feedback distance between the first wireless device and the second wireless device. The method may further include selecting at least one of the RSRP threshold or the threshold distance based on at least one of the PPPP of the first set of V2X transmissions, the cast type of the first set of V2X transmissions, or the feedback distance between the first wireless device and the second wireless device.

Aspect 4 is the method of any of aspects 2 to 3, where the decoded set of first data packets may include a resource reservation interval (RRI) of the first set of V2X transmissions. The indication may include the RRI of the first set of V2X transmissions.

Aspect 5 is the method of any of aspects 2 to 4, where the decoded set of first data packets may include a position of the second wireless device. The method may further include obtaining the distance between the first wireless device and the second wireless device based on the position of the second wireless device.

Aspect 6 is the method of aspect 5, where the decoded set of first data packets may include at least one of a BSM or a zone indicator that indicates the position of the second wireless device.

Aspect 7 is the method of any of aspects 2 to 6, where the decoded set of first data packets may include a retransmission interval of the first set of V2X transmissions. The indication may include the retransmission interval of the first set of V2X transmissions.

Aspect 8 is the method of any of aspects 1 to 7, where the method may further include detecting, prior to communicating the indication, that at least one of: (1) the RSRP associated with the first set of V2X transmissions is greater than the RSRP threshold or (2) the distance between the first wireless device and the second wireless device is less than the threshold distance.

Aspect 9 is the method of any of aspects 1 to 8, where the method may further include measuring the RSRP associated with the first set of V2X transmissions.

Aspect 10 is the method of any of aspects 1 to 9, where the method may further include transmitting a third V2X transmission including a set of third data packets associated with a set of third slots. The third V2X transmission may be transmitted to the second wireless device. The first set of V2X transmissions may be associated with the first RAT. The third V2X transmission may schedule a PSFCH resource for the third V2X transmission. The indication may include the PSFCH resource for the third V2X transmission.

Aspect 11 is the method of any of aspects 1 to 10, where the method may further include communicating the indication by transmitting the indication to a third wireless device using a wireless transceiver.

Aspect 12 is the method of any of aspects 1 to 11, where the method may further include communicating the indication by transmitting the indication to a third wireless device using a wired connection.

Aspect 13 is the method of any of aspects 1 to 12, where the method may further include receiving a fourth V2X transmission including a set of fourth data packets associated with a set of fourth slots. The fourth V2X transmission may be received from a fourth wireless device. The fourth V2X transmission may be associated with the first RAT. The method may further include selecting the RSRP threshold or the threshold distance based on at least one of (1) a second RSRP associated with the fourth V2X transmission being greater than a second RSRP threshold or (2) a second distance between the first wireless device and the fourth wireless device being less than a second threshold distance.

Aspect 14 is the method of aspect 13, where the second RSRP threshold may be greater than the RSRP threshold or the second threshold distance may be less than the threshold distance.

Aspect 15 is the method of any of aspects 1 to 14, where the method may further include obtaining a second indication of congestion. The indication may further be based on the second indication of congestion

Aspect 16 is the method of aspect 15, where the method may further include obtaining a periodicity of the first set of V2X transmissions. The indication may include the periodicity of the first set of V2X transmissions.

Aspect 17 is the method of any of aspects 15 to 16, where the second indication of congestion may include a CBR.

Aspect 18 is the method of aspect 17, where the method may further include selecting at least one of the RSRP threshold or the threshold distance based on the CBR.

Aspect 19 is the method of any of aspects 1 to 18, where the second indication of congestion may include a number of packets received within a time period.

Aspect 20 is a method of wireless communication at a third wireless device, where the method may include obtaining an indication of a set of second slots associated with a second V2X transmission. The second V2X transmission may be subsequent to a first set of V2X transmissions associated with a set of first slots. The set of first slots and the set of second slots may be associated with a candidate resource set. The first set of V2X transmissions and the second V2X transmission may be between a first wireless device and a second wireless device. The first set of V2X transmissions may be associated with a first RAT. The second V2X transmission may be associated with the first RAT. The indication may be based on at least one of: (1) an RSRP associated with the first set of V2X transmissions being greater than an RSRP threshold or (2) a distance between the first wireless device and the second wireless device being less than a threshold distance. The method may further include refraining from transmitting a third V2X transmission in the set of second slots that overlap with the candidate resource set associated with the second V2X transmission based on the indication. The third V2X transmission may be associated with a second RAT different from the first RAT.

Aspect 21 is the method of aspect 20, where the method may further include selecting a set of resources for a fourth V2X transmission based on the set of second slots and the candidate resource set.

Aspect 22 is the method of aspect 21, where the set of resources may include a set of SPS resources for a set of V2X transmissions. The set of V2X transmissions may include the fourth V2X transmission.

Aspect 23 is the method of any of aspects 21 to 22, where the method may further include refraining from transmitting the third V2X transmission further based on at least one of a priority of the third V2X transmission, a remaining PDB of the third V2X transmission, or a number of retransmissions of the third V2X transmission.

Aspect 24 is the method of any of aspects 20 to 23, where the third V2X transmission may include a PSFCH transmission.

Aspect 25 is the method of any aspect 24, where the method may further include refraining from transmitting the third V2X transmission further based on at least one of a feedback mode of the PSFCH transmission, a cast type of the PSFCH transmission, a priority of the PSFCH transmission, or a feedback distance of the PSFCH transmission.

Aspect 26 is the method of any of aspects 20 to 25, where the indication may include at least one of an RRI of the first set of V2X transmissions, a retransmission interval of the first set of V2X transmissions, or a PSFCH resource.

Aspect 27 is the method of any of aspects 20 to 26, where the method may further include obtaining the indication by receiving the indication using a wireless transceiver.

Aspect 28 is the method of any of aspects 20 to 27, where the method may further include obtaining the indication by receiving the indication using a wired connection.

Aspect 29 is an apparatus for wireless communication at a wireless device, including: a memory; and at least one processor coupled to the memory and, based at least in part on information stored in the memory, the at least one processor is configured to implement any of aspects 1 to 28.

Aspect 30 is the apparatus of aspect 29, further including at least one of an antenna or a transceiver coupled to the at least one processor.

Aspect 31 is an apparatus for wireless communication including means for implementing any of aspects 1 to 28.

Aspect 32 is a computer-readable medium (e.g., a non-transitory computer-readable medium) storing computer executable code, where the code when executed by a processor causes the processor to implement any of aspects 1 to 28.

Aspect 33 is a method of wireless communication at a first wireless device, where the method may include receiving a first indication of a set of first slots associated with a first set of V2X transmissions from a second wireless device. The first set of V2X transmissions may be associated with a first RAT. The method may include communicating a second indication of a set of second slots associated with second set of V2X transmissions. The second set of V2X transmissions may be subsequent to the first set of V2X transmissions. The second set of V2X transmissions may be associated with the first RAT. The second indication may be based on at least one of: (1) a reference signal received power (RSRP) associated with the first set of V2X transmissions being greater than an RSRP threshold or (2) a distance between the first wireless device and the second wireless device being less than a threshold distance.

Aspect 34 is the method of aspect 33, where the method may include receiving the first set of V2X transmissions including a first set of data packets associated with the set of first slots. The method may include decoding the set of first data packets in the first set of V2X transmissions after the first set of V2X transmissions is received.

Aspect 35 is the method of any of aspects 33 and 34, where the decoded set of first data packets may include at least one of a priority indication of the first set of V2X transmissions, a cast type of the first set of V2X transmissions, or a communication range between the first wireless device and the second wireless device. The method may include selecting at least one of the RSRP threshold or the threshold distance based on at least one of the priority indication of the first set of V2X transmissions, the cast type of the first set of V2X transmissions, or the communication range between the first wireless device and the second wireless device.

Aspect 36 is the method of aspect 35, where the priority indication may include a PPPP.

Aspect 37 is the method of aspect 34, where the decoded set of first data packets may include an RSRP of the first set of V2X transmissions. The second indication may include the RSVP of the first set of V2X transmissions.

Aspect 38 is the method of any of aspects 34, where the decoded set of first data packets may include a position indication of the second wireless device. The method may include obtaining the distance between the first wireless device and the second wireless device based on the position indication of the second wireless device.

Aspect 39 is the method of aspect 38, where the position indication may include at least one of a BSM, a CAM, or a zone indicator that indicates a position of the second wireless device.

Aspect 40 is the method of aspect 34, where the decoded set of first data packets may include a retransmission interval of the first set of V2X transmissions. The second indication may include the retransmission interval of the first set of V2X transmissions.

Aspect 41 is the method of aspect 40, where the retransmission interval may include a TDRI.

Aspect 42 is the method of any of aspects 33 to 41, where the method may include detecting, prior to communicating the second indication, that at least one of: (1) the RSRP associated with the first set of V2X transmissions is greater than the RSRP threshold or (2) the distance between the first wireless device and the second wireless device is less than the threshold distance.

Aspect 43 is the method of any of aspects 33 to 42, where the method may include transmitting a third V2X transmission including a set of third data packets associated with a set of third slots. The third V2X transmission may be transmitted to the second wireless device. The third V2X transmission may schedule a PSFCH resource for the third V2X transmission. The second indication may include the PSFCH resource for the third V2X transmission.

Aspect 44 is the method of any of aspects 33 to 43, where communicating the second indication of the set of second slots may include communicating the second indication by transmitting the second indication to a third wireless device.

Aspect 45 is the method of any of aspects 33 to 44, where communicating the second indication of the set of second slots may include communicating the second indication by transmitting the second indication to a third wireless device using a wired connection.

Aspect 46 is the method of any of aspects 33 to 45, where the method may include receiving a fourth V2X transmission including a set of fourth data packets associated with a set of fourth slots. The fourth V2X transmission may be received from a fourth wireless device. The method may include selecting the RSRP threshold or the threshold distance based on at least one of (1) a second RSRP associated with the fourth V2X transmission being greater than a second RSRP threshold or (2) a second distance between the first wireless device and the fourth wireless device being less than a second threshold distance.

Aspect 47 is the method of aspect 46, where the second RSRP threshold may be greater than the RSRP threshold or the second threshold distance may be less than the threshold distance.

Aspect 48 is the method of any of aspects 33 to 47, where the method may include obtain a third indication of congestion. The second indication may be further based on the third indication of congestion.

Aspect 49 is the method of aspect 48, where the method may include obtain a periodicity of the first set of V2X transmissions. The second indication may include the periodicity of the first set of V2X transmissions.

Aspect 50 is the method of any aspect 48, where the third indication of congestion may include a CBR.

Aspect 51 is the method of aspect 50, where the method may include selecting at least one of the RSRP threshold or the threshold distance based on the CBR.

Aspect 52 is the method of any of aspects 33 to 51, where the method may include receive the second set of V2X transmissions including a second set of data packets associated with the set of second slots.

Aspect 53 is a method of wireless communication at a third wireless device, where the method may include obtaining an indication of a set of second slots associated with a second set of V2X transmissions. The second set of V2X transmissions may be subsequent to a first set of V2X transmissions associated with a set of first slots. The set of first slots and the set of second slots may be associated with a first candidate resource set. The first set of V2X transmissions and the second set of V2X transmissions may be between a first wireless device and a second wireless device. The first set of V2X transmissions may be associated with a first RAT and the second set of V2X transmissions are associated with the first RAT. The indication may be based on at least one of: (1) an RSRP associated with the first set of V2X transmissions being greater than an RSRP threshold or (2) a distance between the first wireless device and the second wireless device being less than a threshold distance. The method may include refraining from transmitting a third V2X transmission in the set of second slots that interfere with the first candidate resource set associated with the second set of V2X transmissions based on the indication. The third V2X transmission may be associated with a second RAT different from the first RAT.

Aspect 54 is the method of aspect 53, where refraining from transmitting the third V2X transmission may include selecting a second candidate resource set for a fourth V2X transmission based on at least one of the set of second slots and the candidate resource set. The fourth V2X transmission may be associated with the second RAT. Refraining from transmitting the third V2X transmission may include transmitting the fourth V2X transmission based on the second candidate resource set.

Aspect 55 is the method of any of aspects 53 and 54, where the third set of slots may not overlap with the second set of slots.

Aspect 56 is the method of any of aspects 53 to 55, where the second candidate resource set may not interfere with the first candidate resource set.

Aspect 57 is the method of any of aspects 53 to 55, where the method may include transmitting an indication of the set of second slots associated with the third V2X transmission before selecting the second candidate resource set for the fourth V2X transmission.

Aspect 58 is the method of any of aspects 53 to 55, where refraining from transmitting the third V2X transmission may include refraining from transmitting the third V2X transmission further based on at least one of a priority of the third V2X transmission, a remaining PDB of the third V2X transmission, or a number of retransmissions of the third V2X transmission.

Aspect 59 is the method of any of aspects 53 to 55, where the method may include obtaining the indication by receiving the indication using the transceiver.

Aspect 60 is the method of any of aspects 53 to 55, where the method may include obtaining the indication by receiving the indication using a wired connection.

Aspect 61 is an apparatus for wireless communication at a wireless device, including: a memory; and at least one processor coupled to the memory and, based at least in part on information stored in the memory, the at least one processor is configured to implement any of aspects 33 to 60.

Aspect 62 is the apparatus of aspect 61, further including at least one of an antenna or a transceiver coupled to the at least one processor.

Aspect 63 is an apparatus for wireless communication including means for implementing any of aspects 33 to 60.

Aspect 64 is a computer-readable medium (e.g., a non-transitory computer-readable medium) storing computer executable code, where the code when executed by a processor causes the processor to implement any of aspects 33 to 60.

What is claimed is:

1. An apparatus for wireless communication at a first wireless device, comprising:
a memory; and
at least one processor coupled to the memory and, based at least in part on information stored in the memory, the at least one processor is configured to:
receive a first indication of a set of first slots associated with a first set of vehicle-to-everything (V2X) transmissions from a second wireless device, wherein the first set of V2X transmissions is associated with a first radio access technology (RAT); and
communicate a second indication of a set of second slots associated with second set of V2X transmissions, wherein the second set of V2X transmissions are subsequent to the first set of V2X transmissions, wherein the second set of V2X transmissions are associated with the first RAT, wherein the second indication is based on at least one of: (1) a reference signal received power (RSRP) associated with the first set of V2X transmissions being greater than an RSRP threshold or (2) a distance between the first wireless device and the second wireless device being less than a threshold distance.

2. The apparatus of claim 1, wherein the at least one processor is further configured to:
receive the first set of V2X transmissions comprising a first set of data packets associated with the set of first slots; and
decode the set of first data packets in the first set of V2X transmissions after the first set of V2X transmissions is received.

3. The apparatus of claim 2, wherein the decoded set of first data packets comprises at least one of a priority indication of the first set of V2X transmissions, a cast type of the first set of V2X transmissions, or a communication range between the first wireless device and the second wireless device, wherein the at least one processor is further configured to:
select at least one of the RSRP threshold or the threshold distance based on at least one of the priority indication of the first set of V2X transmissions, the cast type of the first set of V2X transmissions, or the communication range between the first wireless device and the second wireless device.

4. The apparatus of claim 3, wherein the priority indication comprises a proximity services (ProSe) per packet priority (PPPP).

5. The apparatus of claim 2, wherein the decoded set of first data packets comprises a resource reservation period (RSVP) of the first set of V2X transmissions, wherein the second indication comprises the RSVP of the first set of V2X transmissions.

6. The apparatus of claim 2, wherein the decoded set of first data packets comprises a position indication of the second wireless device, wherein the at least one processor is further configured to:
obtain the distance between the first wireless device and the second wireless device based on the position indication of the second wireless device.

7. The apparatus of claim 6, wherein the position indication comprises at least one of a basic safety message (BSM), a connected and automated mobility (CAM), or a zone indicator that indicates a position of the second wireless device.

8. The apparatus of claim 2, wherein the decoded set of first data packets comprises a retransmission interval of the first set of V2X transmissions, wherein the second indication includes the retransmission interval of the first set of V2X transmissions.

9. The apparatus of claim 8, wherein the retransmission interval comprises a time domain resource indication (TDRI).

10. The apparatus of claim 1, wherein the at least one processor is further configured to:
detect, prior to communicating the second indication, that at least one of: (1) the RSRP associated with the first set of V2X transmissions is greater than the RSRP threshold or (2) the distance between the first wireless device and the second wireless device is less than the threshold distance.

11. The apparatus of claim 1, wherein the at least one processor is further configured to:
transmit a third V2X transmission including a set of third data packets associated with a set of third slots, wherein the third V2X transmission is transmitted to the second wireless device, wherein the third V2X transmission schedules a physical sidelink feedback channel (PSFCH) resource for the third V2X transmission, wherein the second indication includes the PSFCH resource for the third V2X transmission.

12. The apparatus of claim 1, further comprising a transceiver coupled to the at least one processor, wherein, to communicate the second indication of the set of second slots, the at least one processor is further configured to:
communicate the second indication by transmitting the second indication to a third wireless device using the transceiver.

13. The apparatus of claim 1, wherein, to communicate the second indication of the set of second slots, the at least one processor is further configured to:
communicate the second indication by transmitting the second indication to a third wireless device using a wired connection.

14. The apparatus of claim 1, wherein the at least one processor is further configured to:
receive a fourth V2X transmission including a set of fourth data packets associated with a set of fourth slots, wherein the fourth V2X transmission is received from a fourth wireless device; and
select the RSRP threshold or the threshold distance based on at least one of (1) a second RSRP associated with the fourth V2X transmission being greater than a second RSRP threshold or (2) a second distance between the first wireless device and the fourth wireless device being less than a second threshold distance.

15. The apparatus of claim 14, wherein the second RSRP threshold is greater than the RSRP threshold or the second threshold distance is less than the threshold distance.

16. The apparatus of claim 1, wherein the at least one processor is further configured to:
obtain a third indication of congestion, wherein the second indication is further based on the third indication of congestion.

17. The apparatus of claim 16, wherein the at least one processor is further configured to:
obtain a periodicity of the first set of V2X transmissions, wherein the second indication comprises the periodicity of the first set of V2X transmissions.

18. The apparatus of claim 16, wherein the third indication of congestion comprises a channel busy ratio (CBR).

19. The apparatus of claim 18, wherein the at least one processor is further configured to:
select at least one of the RSRP threshold or the threshold distance based on the CBR.

20. The apparatus of claim 1, wherein the at least one processor is further configured to:
receive the second set of V2X transmissions comprising a second set of data packets associated with the set of second slots.

21. An apparatus for wireless communication at a third wireless device, comprising:
a memory; and
at least one processor coupled to the memory and, based at least in part on information stored in the memory, the at least one processor is configured to:
obtain an indication of a set of second slots associated with a second set of vehicle-to-everything (V2X) transmissions, wherein the second set of V2X transmissions are subsequent to a first set of V2X transmissions associated with a set of first slots, wherein the set of first slots and the set of second slots are associated with a first candidate resource set, wherein the first set of V2X transmissions and the second set of V2X transmissions are between a first wireless device and a second wireless device, wherein the first set of V2X transmissions is associated with a first radio access technology (RAT) and the second set of V2X transmissions are associated with the first RAT, wherein the indication is based on at least one of: (1) a reference signal received power (RSRP) associated with the first set of V2X transmissions being greater than an RSRP threshold or (2) a distance between the first wireless device and the second wireless device being less than a threshold distance; and
refrain from transmitting a third V2X transmission in the set of second slots that interfere with the first candidate resource set associated with the second set of V2X transmissions based on the indication, wherein the third V2X transmission is associated with a second RAT different from the first RAT.

22. The apparatus of claim 21, wherein, to refrain from transmitting the third V2X transmission, the at least one processor is further configured to:
select a second candidate resource set for a fourth V2X transmission based on at least one of the set of second slots and the candidate resource set, wherein the fourth V2X transmission is associated with the second RAT; and
transmit the fourth V2X transmission based on the second candidate resource set.

23. The apparatus of claim 22, wherein the second candidate resource set do not overlap with the second set of slots.

24. The apparatus of claim 22, wherein the second candidate resource set does not interfere with the first candidate resource set.

25. The apparatus of claim 22, the at least one processor is configured to:
transmit an indication of the set of second slots associated with the third V2X transmission before selecting the second candidate resource set for the fourth V2X transmission.

26. The apparatus of claim 21, wherein, to refrain from transmitting the third V2X transmission, the at least one processor is further configured to:
refrain from transmitting the third V2X transmission further based on at least one of a priority of the third V2X transmission, a remaining packet delay budget (PDB) of the third V2X transmission, or a number of retransmissions of the third V2X transmission.

27. The apparatus of claim 21, further comprising a transceiver coupled to the at least one processor, wherein the at least one processor is further configured to:
obtain the indication by receiving the indication using the transceiver.

28. The apparatus of claim 21, wherein the at least one processor is further configured to:
obtain the indication by receiving the indication using a wired connection.

29. A method of wireless communication at a first wireless device, comprising:
receiving a first indication of a set of first slots associated with a first vehicle-to-everything (V2X) transmission from a second wireless device, wherein the first set of V2X transmissions is associated with a first radio access technology (RAT); and
communicating a second indication of a set of second slots associated with second set of V2X transmissions, wherein the second set of V2X transmissions are subsequent to the first set of V2X transmissions, wherein the set of first slots and the set of second slots are associated with a candidate resource set, wherein the second set of V2X transmissions are associated with the first RAT, wherein the second indication is based on at least one of: (1) an reference signal received power (RSRP) associated with the first set of V2X transmissions being greater than an RSRP threshold or (2) a distance between the first wireless device and the second wireless device being less than a threshold distance.

30. A method of wireless communication at a third wireless device, comprising:
obtaining an indication of a set of second slots associated with one or more second vehicle-to-everything (V2X) transmissions, wherein the second set of V2X transmissions are subsequent to a first set of V2X transmissions associated with a set of first slots, wherein the set of first slots and the set of second slots are associated with a candidate resource set, wherein the first set of V2X transmissions and the second set of V2X transmissions are between a first wireless device and a second wireless device, wherein the first set of V2X transmissions is associated with a first radio access technology (RAT) and the second set of V2X transmissions are associated with the first RAT, wherein the indication is based on at least one of: (1) an RSRP associated with the first set of V2X transmissions being greater than an RSRP threshold or (2) a distance between the first wireless device and the second wireless device being less than a threshold distance; and
refraining from transmitting a third V2X transmission in the set of second slots of the candidate resource set associated with the second V2X transmission based on the indication, wherein the third V2X transmission is associated with a second RAT different from the first RAT.
